(19) United States
(12) Patent Application Publication
(10) Pub. No.: US 2017/0154309 A1
(43) Pub. Date: Jun. 1, 2017

(54) DETERMINING AND DISPLAYING SIMILAR EMPLOYEES BASED ON EMPLOYMENT ROLE

(71) Applicant: Linkedin Corporation, Mountain View, CA (US)

(72) Inventors: Anthony Duane Duerr, Castro Valley, CA (US); Dan Shapero, Palo Alto, CA (US); Vidya Chandrasekaran, Mountain View, CA (US); Jeremy Lwanga, San Francisco, CA (US); Kunal Mukesh Cholera, Mountain View, CA (US); Chih-Chiang Chang, San Jose, CA (US); Lauren Kelly, San Francisco, CA (US); Chih Cheng Paul Yuan, Sunnyvale, CA (US); Xiaodan Sun, Sunnyvale, CA (US); Jiuling Wang, San Jose, CA (US)

(21) Appl. No.: 15/056,951

(22) Filed: Feb. 29, 2016

Related U.S. Application Data
(60) Provisional application No. 62/261,139, filed on Nov. 30, 2015.

(51) Int. Cl. G06Q 10/10; G06F 17/30; G06F 17/27; G06Q 50/00

(52) U.S. Cl. CPC G06Q 10/1053; G06Q 50/01; G06F 17/30867; G06F 17/2705; G06F 17/3053

(57) ABSTRACT

A system and method for determining similar members in an organization is disclosed. In some example embodiments, the social networking system receives a request for a particular job listing from a client system associated with a first member of a social networking system. The social networking system determines a first employment role for a job associated with the particular job listing. The social networking system identifies a source organization for the particular job listing. The social networking system identifies one or more similar members, wherein each identified similar member is associated with the source organization and has an employment role similar to the first employment role. The social networking system communicates the particular job listing and the identified one or more similar members to the client system for display.

### TECHNICAL FIELD

The disclosed example embodiments relate generally to the field of social networks and, in particular, to improving job listing data.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

Another service provided over networks is social networking. Large social networks allow members to connect with each other and share information. One such type of information is information about available jobs.

Social networks enable members to share and view information about job openings to and from a wide variety of potential markets. In addition, social networks allow a member's social network to influence the type of job opportunities they see and how they evaluate those opportunities. Job openings can be listed by employers and shared with interested members of the social networking system.

### DESCRIPTION OF THE DRAWINGS

Some example embodiments are illustrated by way of example and not limitation in the figures of the accompanying drawings, in which:

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 is a block diagram of an exemplary data structure for storing member profiles, in accordance with some example embodiments.

FIGS. 5A-5E are user interface diagrams illustrating an example of a user interface, in accordance with some example embodiments.

FIG. 6A is a block diagram illustrating a system for identifying members with employment roles in an organization similar to a role described in a job listing posted by the organization, in some example embodiments.

FIG. 6B is a block diagram illustrating a system for identifying important skills that are missing from a particular group of members based on a reference list of skills, in some example embodiments.

FIG. 6C is a block diagram illustrating a system for identifying potential co-workers for a job described in a particular job listing, in some example embodiments.

FIG. 7 is a flow diagram illustrating a method, in accordance with some example embodiments, for identifying members with employment roles in an organization similar to a role described in a job listing posted by the organization.

FIG. 8 is a flow diagram illustrating a method, in accordance with some example embodiments, for identifying skills missing from a group of members relative to a reference list of skills.

FIG. 9 is a flow diagram illustrating a method, in accordance with some example embodiments, for identifying potential co-workers for a job described in a particular job listing.

FIGS. 10A-10C are flow diagrams illustrating a method, in accordance with some example embodiments, for identifying members with employment roles in an organization similar to a role described in a job listing posted by the organization.

FIGS. 11A-11B are flow diagrams illustrating a method, in accordance with some example embodiments, for identifying skills missing from a group of members relative to a reference list of skills

FIGS. 12A-12B are flow diagrams illustrating a method, in accordance with some example embodiments, for identifying potential co-workers for a job described in a particular job listing.

FIG. 13 is a block diagram illustrating an architecture of software, which may be installed on any of one or more devices, in accordance with some example embodiments.

FIG. 14 is a block diagram illustrating components of a machine, according to some example embodiments.

Like reference numerals refer to corresponding parts throughout the drawings.

### DETAILED DESCRIPTION

The present disclosure describes methods, systems, and computer program products for providing improved job listing information for members of a social networking system. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

A member of the social networking system can, though a user interface presented at a client system, search through a plurality of job listings stored in a database of job listings. When the member selects a particular job, the social networking system determines an organization associated with the selected job listing.

In addition, the social networking system identifies one or more skills associated with the job listing. In some example embodiments, the job listing will explicitly identify one or more skills associated with the job listing. In other example embodiments, the social networking system parses the language included in the job listing (e.g., the job description, job requirements, and so on) to determine one or more skills associated with the job listing.

In some example embodiments, the social networking system identifies a job role from the job listing. In some example embodiments, the social networking system stores a list or database of possible job roles. When a member lists a current or former job or an employer lists a job opening, the social networking system matches the listed job with one of the stored job roles or job templates. Thus, members with similar job responsibilities and skills can be grouped into a common group even if their job titles or industries are not similar.

Using the identified job role and the organization associated with a particular job listing, the social networking system is able to identify members who have the same job role at the same organization.

Thus, when the social networking system displays a selected job listing to a member, other employees of the same organization who perform the same role can also be displayed in the user interface. The member can use displayed information about the other employees to determine whether or not the particular job listing is a good fit for them. In some example embodiments, no employee information is shared unless the employee explicitly allows the information to be shared.

In some example embodiments, when the social networking system receives a request from a member (e.g., via a computer network) to view a particular job listing, the social networking system determines the organization associated with the particular job listing. Then the social networking system determines a list of skills associated with the organization. In some example embodiments, the list of skills primarily includes skills associated with the particular job listing.

The social networking system generates a list of skills associated with the requesting member (e.g., the member requesting the job listing). In some example embodiments, the list of skills is generated based on explicit skill information provided by the member. In other example embodiments, the social networking system uses information about the member's current job, job history, education, and so on to generate the list of skills implicitly.

The social networking system uses the list of skills associated with the particular job listing, the list of skills associated with the organization associated with the job listing, and the list of skills associated with the requesting member to determine one or more skills that the requesting member has that are either required by the job listing or would be helpful in the job described in the job listing that are missing or underrepresented in the organization associated with the particular job listing.

Once the social networking system has determined one or more skills that are currently missing or underrepresented at the associated organization, a description of those skills is transmitted to the requesting member. In some example embodiments, a requesting member may use this information when determining whether to apply for the job described in the job listing.

In some example embodiments, the social networking system associates specific job listings with a particular set of employees in a given organization. In some example embodiments, the set of employees are the employees that the newly hired employee (e.g., hired based on the job listing) is expected to work with.

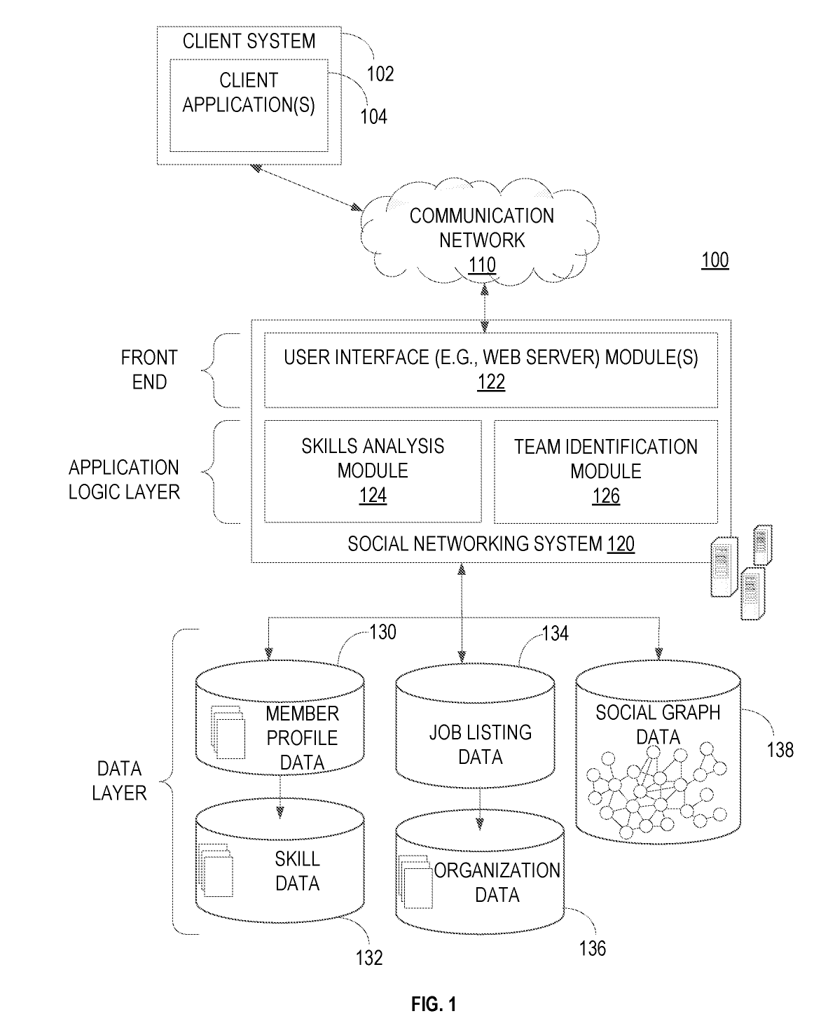

FIG. 1 is a network diagram depicting a client-social networking system environment 100 that includes various functional components of a social networking system 120, in accordance with some example embodiments. The client-social networking system environment 100 includes one or more client systems 102 and the social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses the web browser to send and receive requests to and from the social networking system 120 and displays information received from the social networking system 120.

In some example embodiments, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some example embodiments, the client system 102 sends a request to the social networking system 120 for a webpage associated with the social networking system 120. For example, a member uses a client system 102 to log into the social networking system 120 and clicks a link to view a job listing for a job they are interested in from the social networking system 120. In response, the client system 102 receives the requested job listing data (e.g., data describing the position, the associated organization, and the job requirements and responsibilities) and displays that data in a user interface on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although the social networking system 120 is depicted in FIG. 1 as a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transfer Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, skill data 132 (e.g., data describing the skills of one or more members of the social networking system 120), job listing data 134 (e.g., data describing one or more available jobs including the job title, requirements, and responsibilities), organization data 136, and social graph data 138, which is data stored in a particular type of database that uses graph structures with nodes, edges, and properties to represent and store data. Of course, in various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes the skill data 132. In other example embodiments, the skill data 132 is distinct from, but associated with, the member profile data 130. The skill data 132 stores skill data for each member of the social networking system 120. Skills stored in the skill data 132 include both explicit skills and implicit skills.

In some example embodiments, explicit skills are skills that the member is determined to have based on skill information directly received from the member. For example, a member reports that they have skills in using the C++, Java, PHP, CSS, and Python programming languages. Because the member directly reported these skills they are considered explicit skills. In some example embodiments, explicit skills are listed on a member's public profile.

In some example embodiments, one or more skills are determined based on an analysis of the non-skill data stored in a member profile. Skills determined in this way are considered implicit skills. Implicit skills are determined or inferred by analyzing data stored in a member profile, including but not limited to education, job history, hobbies, friends, skill ratings, interests, projects a member has worked on, activity on the social networking system 120, and member-submitted comments. In some example embodiments, implicit skills may also be called “inferred skills” or “skills a member may have”. For example, member A lists an undergraduate degree in architecture and has a past job history that includes Project Architect for at least three different projects. The social networking system 120 determines that member A has skill in AutoCAD even though member A has not directly reported having that skill. In some example embodiments, implicit skills are not listed on a member's public profile.

The job listing data 134 stores data related to one or more job listings. Job listings are created in response to a request from a member or organization to list a job opening on the social networking system 120. Job listings include, but are not limited to, the job title, the job role, a description of the job requirements, a description of the job responsibilities, compensation data, skills associated with the job, the organization associated with the job, the specific location of the job, one or more potential evaluators for the job, one or more teams within an organization with which the job is associated, and one or more members who are likely co-workers associated with the job.

The organization data 136 stores data related to organizations on the social networking system 120 and their members. Thus, members of the social networking system 120 may be associated with employers, customers, and other organizations such as schools, professional groups, and non-profit organizations (e.g., based on interests, family connections, schools, employers, etc.) Each organization, therefore, includes a list of associated member employees, a list of open job listings, a location, a business field, and so on.

Once registered, a member may invite other members, or be invited by other members, to connect via the social networking system 120. A “connection” may include a bilateral agreement by the members, such that both members acknowledge the establishment of the connection. Similarly, in some example embodiments, a member may elect to “follow” another member. In contrast to establishing a “connection,” the concept of “following” another member typically is a unilateral operation and, at least in some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, often customized to the interests of the member. In some example embodiments, the social networking service may include a photo sharing application that allows members to upload and share photos with other members. As such, at least in some example embodiments, a photograph may be a property or entity included within a social graph. In some example embodiments, members of a social networking service may be able to self-organize into groups, or interest groups, organized around subject matter or a topic of interest. In some example embodiments, the data for a group may be stored in a database. When a member joins a group, his or her membership in the group will be reflected in stored organization interaction data, member interaction data, and the social graph data 138.

In some example embodiments, the application logic layer includes various application server modules, which, in conjunction with the user interface module(s) 122, generate various user interfaces (e.g., web pages) with data retrieved from various data sources in the data layer. In some example embodiments, individual application server modules are used to implement the functionality associated with various applications, services, and features of the social networking service. For instance, a skills analysis module 124 or a team identification module 126, or some hybrid or variation of the two, may be implemented with one or more application server modules. Similarly, a search engine enabling members to search for and browse member profiles may be implemented with one or more application server modules. Of course, other applications or services that utilize the skills analysis module 124 or the team identification module 126 may be separately implemented in their own application server modules.

In addition to the various other application server modules, the application logic layer includes the skills analysis module 124 or the team identification module 126. As illustrated in FIG. 1, in some example embodiments, the skills analysis module 124 or the team identification module 126 are implemented as services that operate in conjunction with various other application server modules. For instance, any number of individual application server modules can invoke the functionality of the skills analysis module 124 or the team identification module 126. However, in various alternative example embodiments, the skills analysis module 124 or the team identification module 126 may be implemented as their own application server modules such that they operate as standalone applications. In some example embodiments, the skills analysis module 124 or the team identification module 126 include or have an associated publicly available API that enables third-party applications to invoke the functionality they provide.

Generally, the skills analysis module 124 is accessed when a job listing request is received or when a job listing entry is added to the job listing data 134. The skills analysis module 124 determines a list of skills associated with the job listings. In some example embodiments, the skills analysis module 124 parses the text of the job listings to determine one or more skill keywords (e.g., words that are highly associated with particular skills, such as Python, which is related to the Python programming language skill). In other example embodiments, each job listing includes an associated list of skills that are required or recommended for the job.

In some example embodiments, the skills analysis module 124 also analyzes the member profile of each member (with member consent) to determine a list of explicit or implicit skills for that member. In some example embodiments, the skills analysis module 124 determines, using two groups of skills, whether any particular skill is present in one group but not in another. In this way, the skills analysis module 124 can determine whether a member has a skill that is currently missing from a particular set of employees at an organization.

For example, if a job listing requires five skills, the skills analysis module 124 determines whether any employees at the associated organization have the required skills. Similarly, the skills analysis module 124 determines whether the requesting member has some or all of the required skills. In some example embodiments, if the skills analysis module 124 determines that the requesting member has a skill required by the listing that is not among the skills of the current employees of the organization, the skills analysis module 124 determines that the requesting member is a good fit for the job listing.

Once a list of skills has been identified for a particular job listing, the team identification module 126 determines a group of members at the organization associated with the job listing that have the same or a similar role or job function as the job described in the job listing. In some example embodiments, the team identification module 126 determines a particular role associated with the job listing based on the industry of the associated organization, the skills recommended or required based on the job listing, and the job title.

Once the role of a job listing has been determined (e.g., from a database of job roles), the team identification module 126 determines other members at the organization associated with the job listing with the same role.

Once these members have been identified, the social networking system 120 transmits the job listing and the identified members with similar roles at the same organization to the client system 102 for display. In some example embodiments, the listing and the members with similar roles are display in a user interface presented at the client system 102.

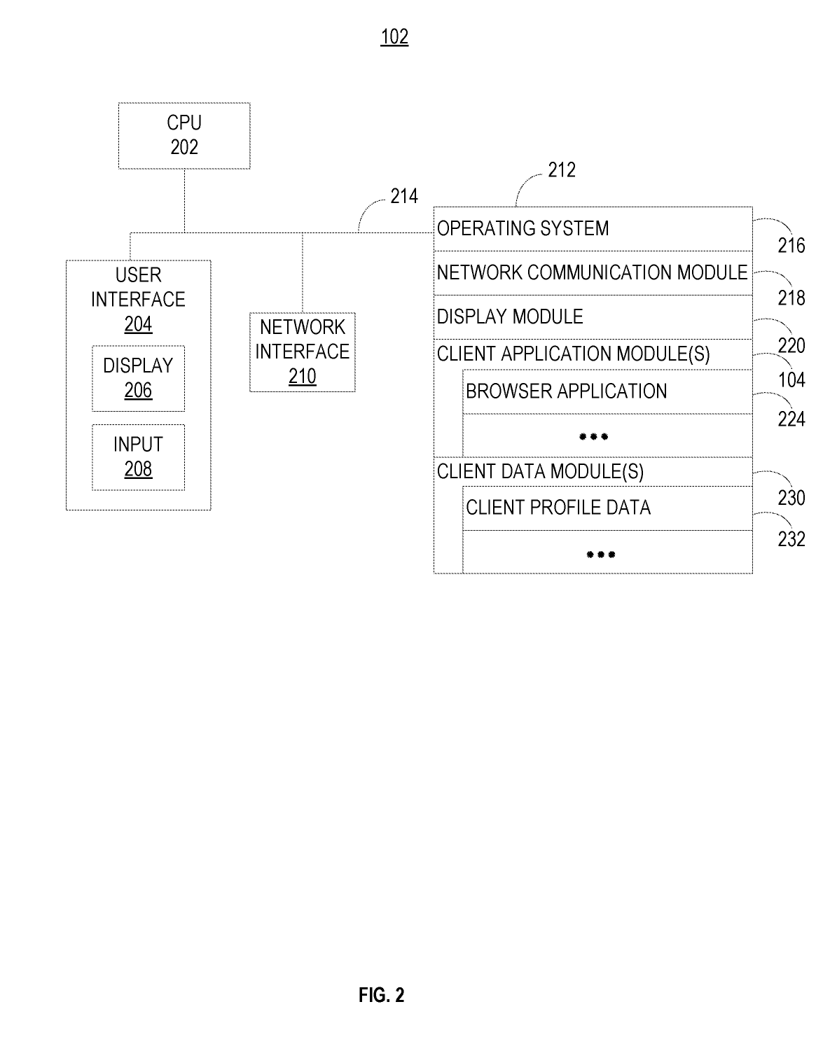

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM), or other random access solid state memory devices, and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer-readable storage medium.

In some example embodiments, memory 212, or the computer-readable storage medium of memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client applications 104 for handling various aspects of interacting with the social networking system 120 (FIG. 1), including but not limited to:
   a browser application 224 for requesting information from the social networking system 120 (e.g., job listings) and receiving responses from the social networking system 120; and
client data module(s) 230 for storing data relevant to the clients, including but not limited to:
   client profile data 232 for storing profile data related to a member of the social networking system 120 associated with the client system 102.

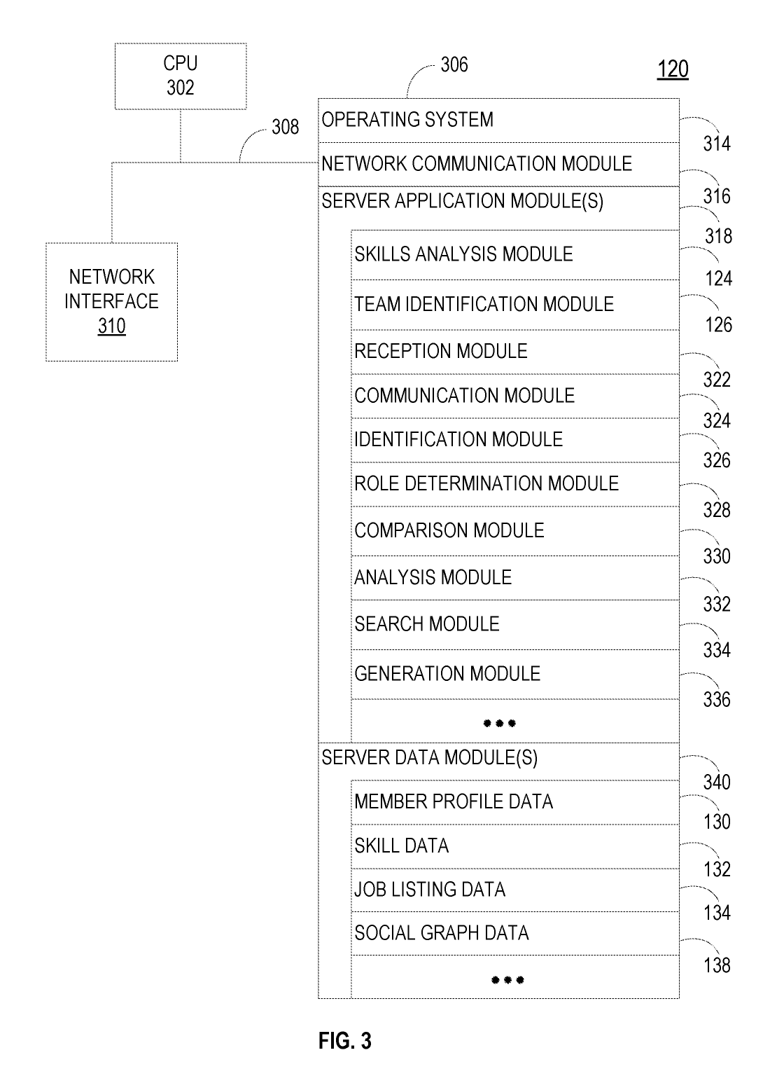

FIG. 3 is a block diagram further illustrating the social networking system 120, in accordance with some example embodiments. Thus, FIG. 3 is an example embodiment of the social networking system 120 in FIG. 1. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer-readable storage medium. In some example embodiments, memory 306, or the computer-readable storage medium of memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more network interfaces 310 (wired or wireless) and one or more communication networks 110, such as the Internet, other WANs, LANs, MANs, and so on;
one or more server application modules 318 for performing the services offered by the social networking system 120, including but not limited to:
   a skills analysis module 124 for determining, based on a particular job listing, one or more skills required by or recommended for the job associated with the job listing, wherein the title of the job listing, the list of responsibilities, or the required skills or experience can all be used to determine one or more required skills;
   a team identification module 126 for determining one or more members who have a job role that matches or is similar to the job role described in a particular job listing who are currently employed by the source organization of the job listing or for determining likely co-workers for a job described in a particular job listing;
   a reception module 322 for receiving requests to view a particular job listing, requests to view members who have jobs similar to the job described in a job listing, requests to see a list of skills available at a particular organization, requests to see a list of likely co-workers, and so on;
   a communication module 324 for transmitting data to and receiving data from a client system (e.g., the client system 102 in FIG. 1) or third party system over a computer network;
   an identification module 326 for identifying a source organization for a job listing, identifying similar members at an organization given a particular employment role, and so on;
   a role determination module 328 for determining an employment role associated with a particular member or job listing based on data stored at the social networking system 120, including but not limited to job title, job experience, job compensation, job responsibilities, required skills, communication events (e.g., which other members a particular member communicates with most frequently), and the industrial area of the source organization;
   a comparison module 330 for comparing a first set of skills (e.g., skills required by a job listing) with a second set of reference skills (e.g., skills associated with a requesting member) and determining one or more missing skills;
   an analysis module 332 for determining one or more required skills based on a job listing;
   a search module 334 for searching a database of members to determine members whose skills are similar to those required for a particular job described in a job listing or who are likely co-workers of a job based, at least in part, on information stored in the job listing; and
   a generation module 336 for generating a job match score based on a comparison between the list of required skills associated with a job listing and the list of skills associated with the requesting member; and
server data module(s) 340, holding data related to the social networking system 120, including but not limited to:
   member profile data 130 including both data provided by the member, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data, overall trend data for the social networking system 120, and so on;
   skill data 132 including data representing a member's stated or inferred skills;
   job listing data 134 including data describing one or more job opportunities including a source organization, one or more required skills, a job title, a location, a team name, a compensation amount, a list of responsibilities and requirements, and so on; and
   social graph data 138 including data that represents members of the social networking system 120 and the social connections between them.

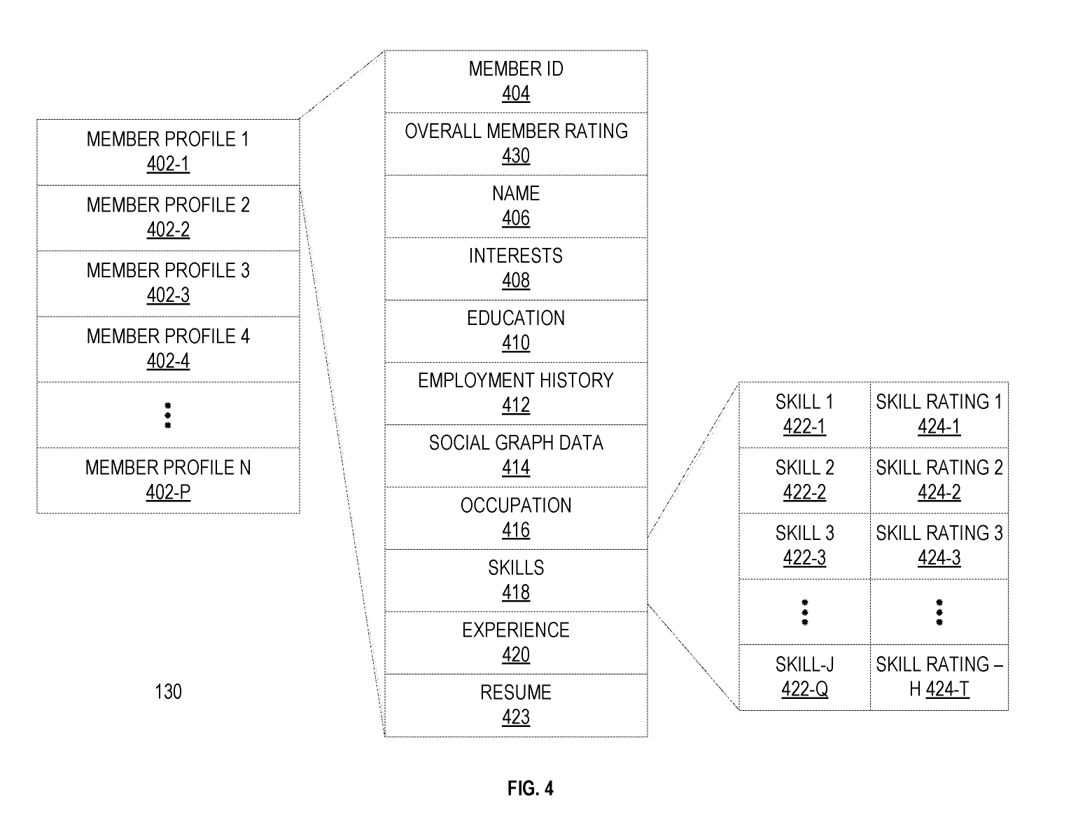

FIG. 4 is a block diagram of an exemplary data structure for the member profile data 130 for storing member profiles in accordance with some example embodiments. In accordance with some example embodiments, the member profile data 130 includes a plurality of member profiles 402-1 to 402-P, each of which corresponds to a member of the social networking system 120.

In some example embodiments, a respective member profile 402 stores a unique member ID 404 for the member profile 402, the overall member rating 430 for the member, a name 406 for the member (e.g., the member's legal name), member interests 408, member education history 410 (e.g., the high school and universities the member attended and the subjects studied), employment history 412 (e.g., member's past and present work history with job titles), social graph data 414 (e.g., a listing of the member's relationships as tracked by the social networking system 120), occupation 416, skills 418, experience 420 (for listing experiences that don't fit under other categories like community service or serving on the board of a professional organization), and a detailed member resume 423.

In some example embodiments, a member profile 402 includes a list of skills (422-1 to 422-Q) and associated skill ratings (424-1 to 424-T). Each skill 422 represents a skill or ability that the member associated with the member profile 402 has. For example, a computer programmer might list FORTRAN as a skill. In addition, each skill has an associated skill rating 424. In some example embodiments, a skill rating 424 represents the social networking system's 120 estimation of the member's proficiency in a skill. For example, the skill rating 424 could be a number from 1 to 100 wherein 100 represents the highest level of skill and 1 represents the lowest. Thus, a member who had AutoCAD with a skill rating of 25 would be less proficient using AutoCAD than a member with a skill rating of 78. In some example embodiments, an overall member rating 430 is generated based on feedback from other members (e.g., recommendations or endorsements) and based on the information stored in the member profile 402 associated with the member.

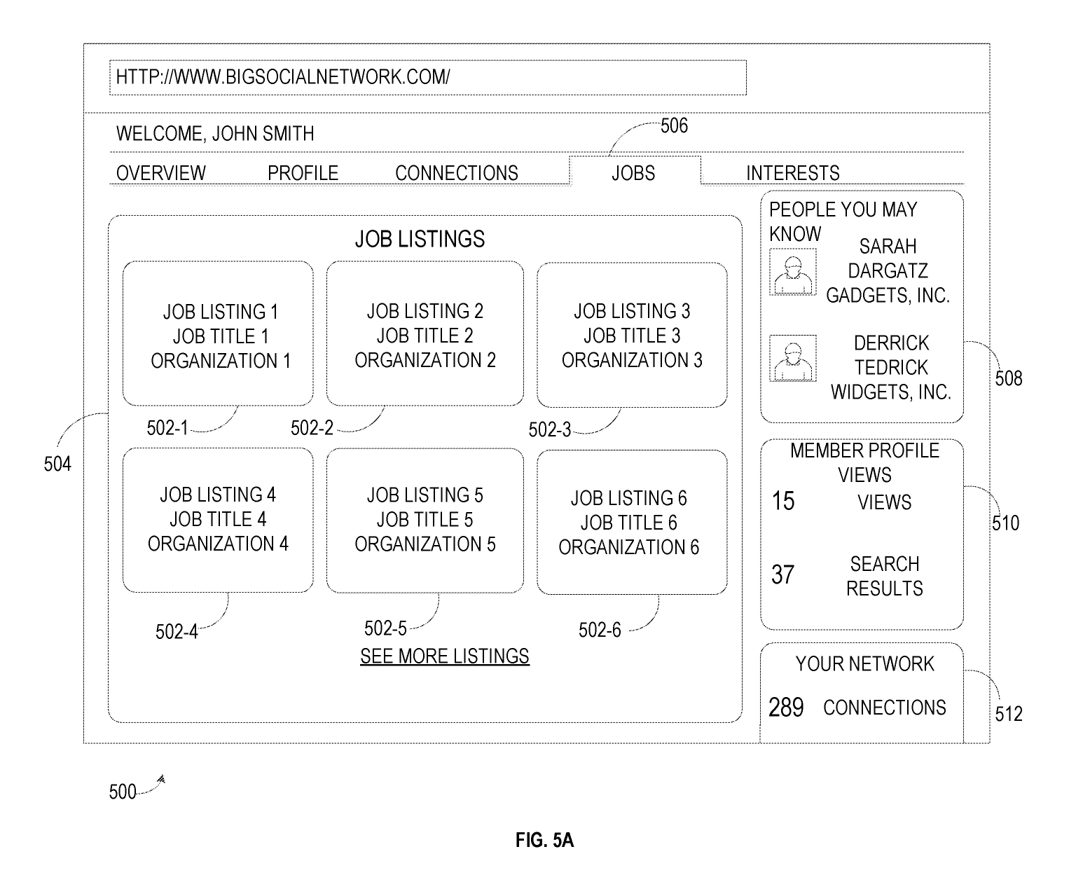

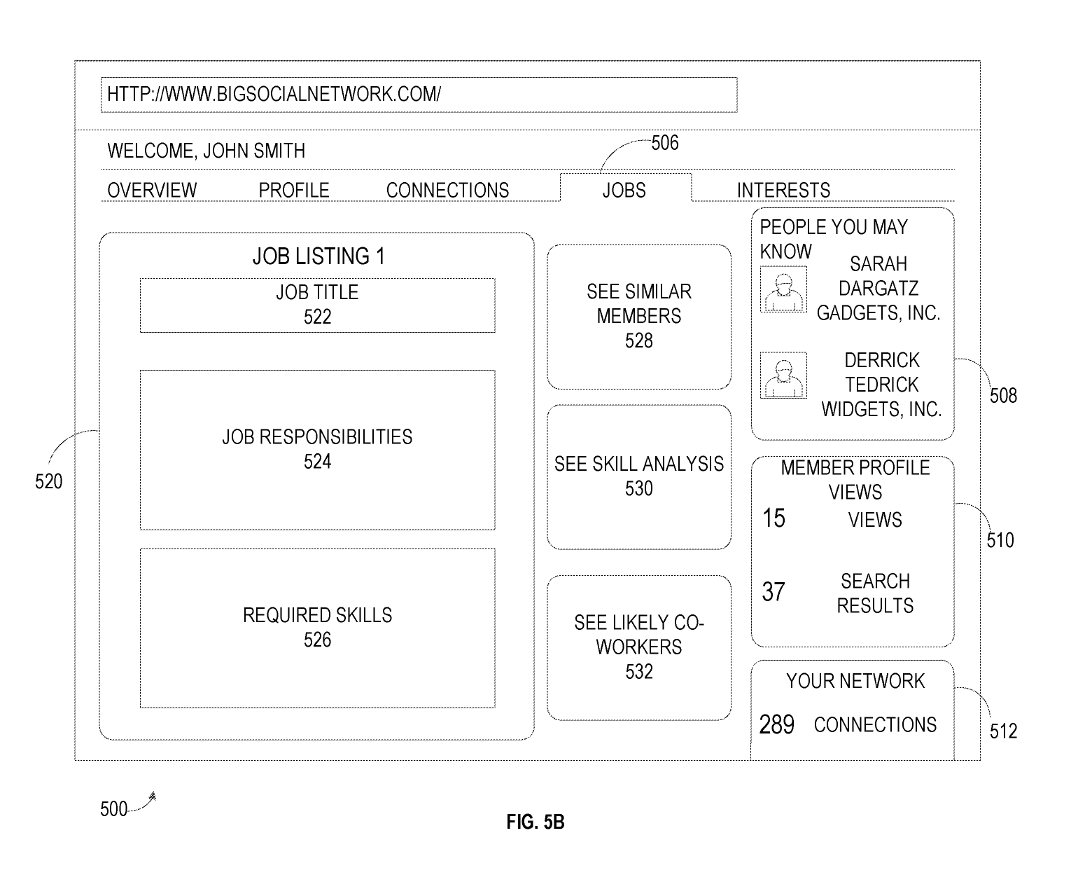

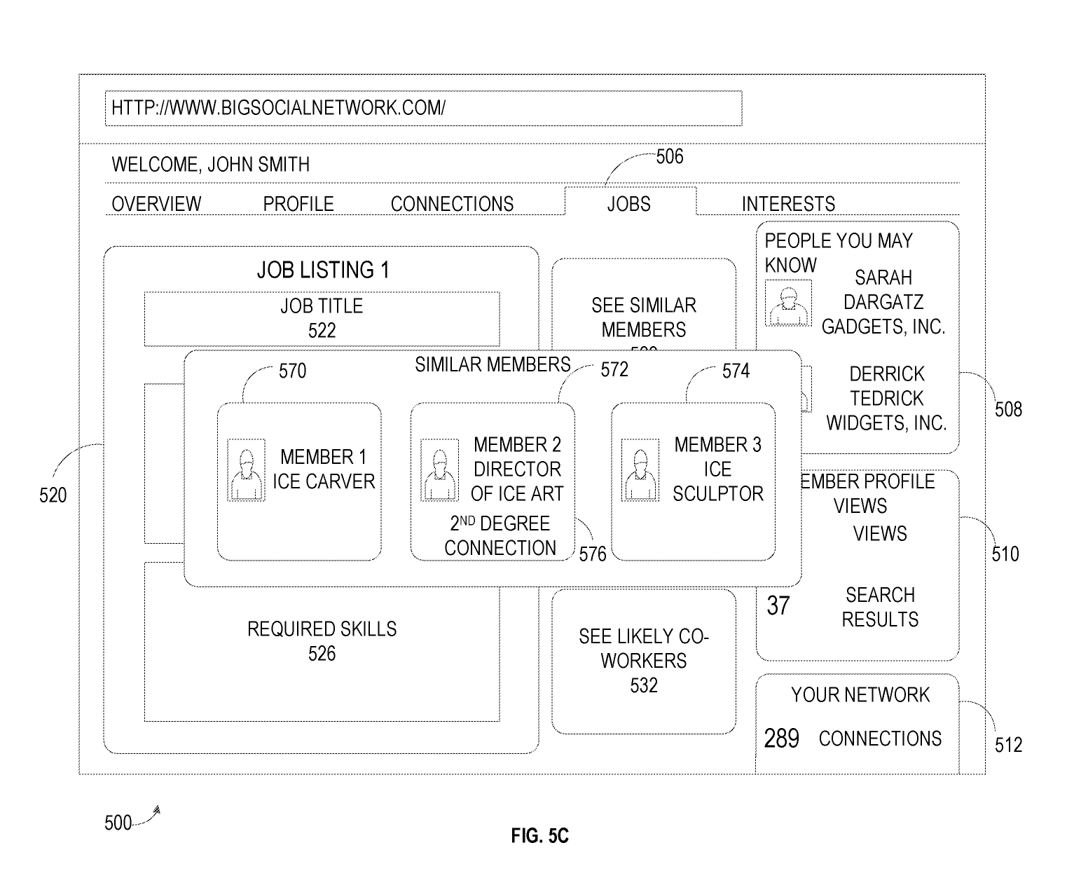

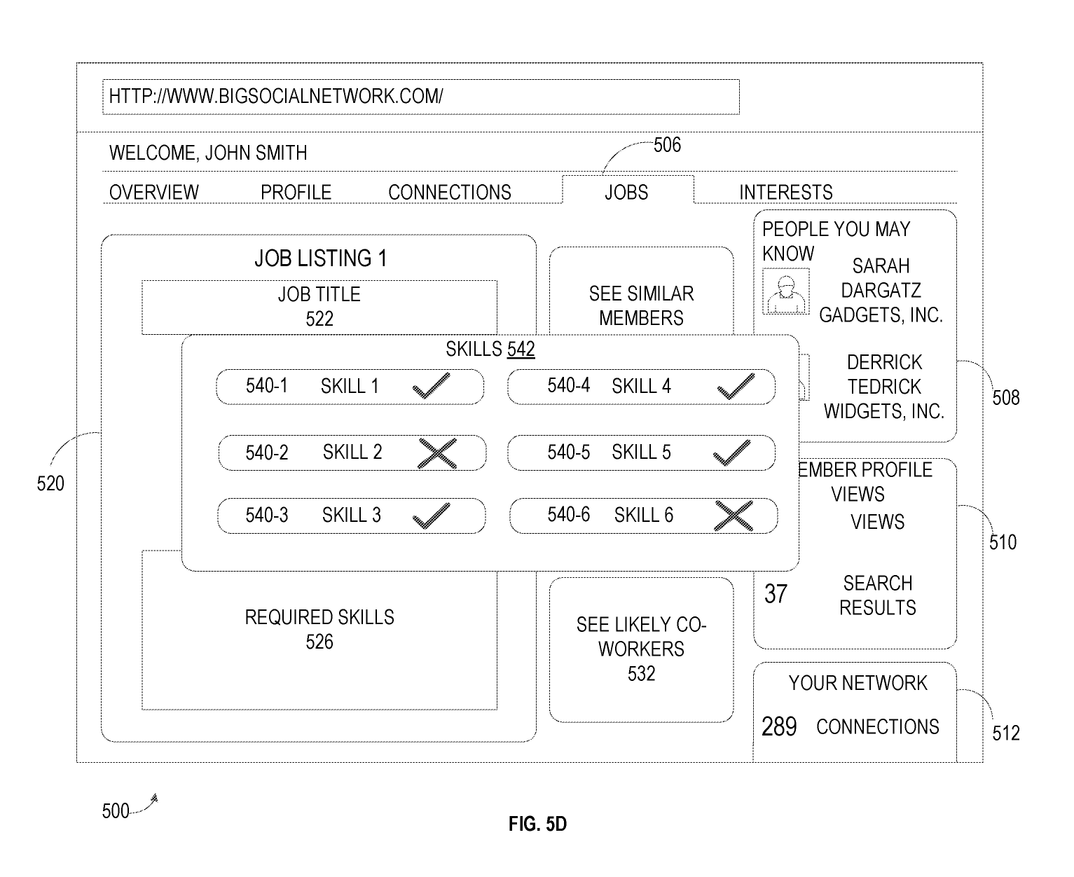

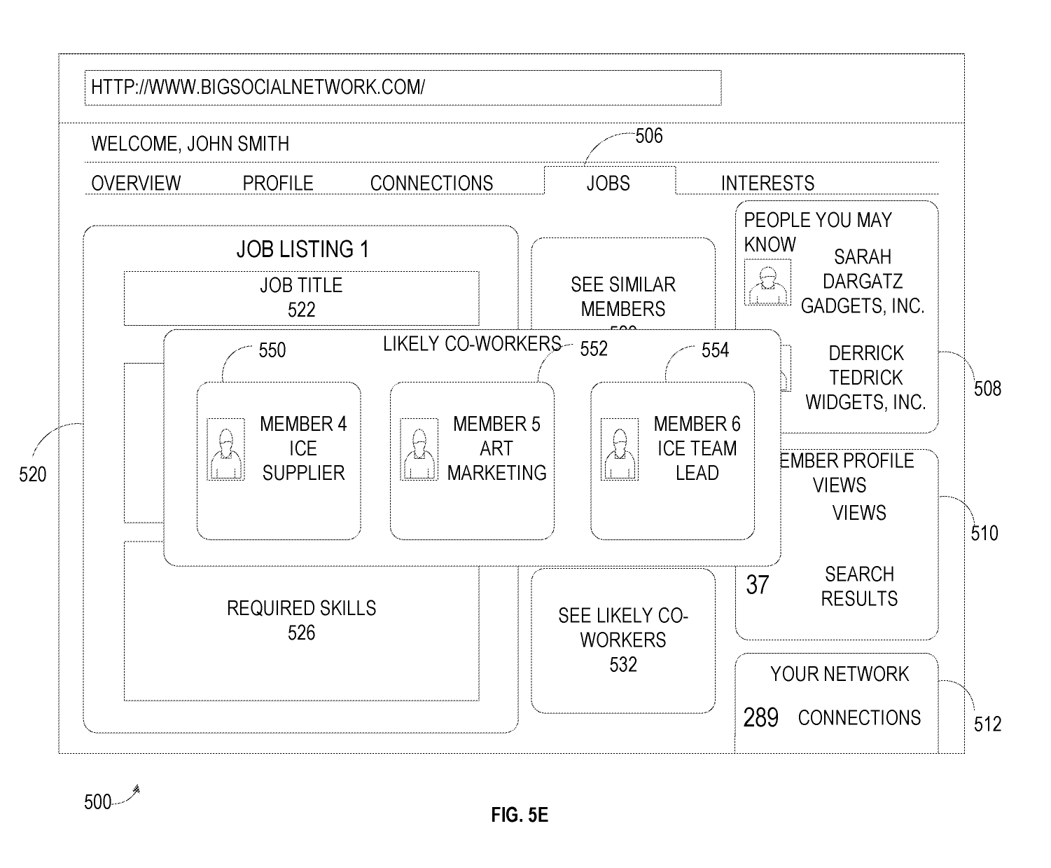

FIG. 5A is a user interface diagram illustrating an example of a user interface 500 or web page that incorporates one or more job listings into a social networking service. In the example user interface 500 of FIG. 5A, the displayed user interface represents a web page for a member of the social networking service with the name John Smith.

As can be seen, a jobs tab 506 has been selected and a job listings page 504 is displayed. The job listings page 504 includes a plurality of job listings 502-1 to 502-6, wherein each job listing 502 displays a job listing time, a job title, and an associated organization. Members can then select particular job listings to get additional information and the ability to contact the associated organization.

The user interface 500 also includes information in side sections of the user interface 500 including a contact recommendation section 508, a profile viewership statistic section 510, and a social graph statistic section 512.

FIG. 5B is a user interface diagram illustrating an example of a user interface 500 or web page that displays a job listing in response to selection of the job listing by a member, and represents a continuation of FIG. 5A. FIG. 5B displays a selected job details pane 520 in the jobs tab 506.

Each job details pane 520 includes at least a job title 522, a list of job responsibilities 524, and one or more required skills 526.

In this example, the user interface 500 also includes a plurality of links that allow the member to request further information about the job details pane 520. For example, a see similar members link 528 can be selected to find members at the source organization that have the same role as the job described in the job details pane 520.

The example further includes a see skill analysis link 530. A member can select the see skill analysis link 530 to see an analysis of which required skills 526 are missing or underrepresented at the source organization. The example further includes a see likely co-workers link 532 that, when selected, will display member information for one or more members likely to be co-workers for the job described in the job details pane 520.

The user interface 500 also includes information in side sections of the user interface 500 including a contact recommendation section 508, a profile viewership statistic section 510, and a social graph statistic section 512.

FIG. 5C is a user interface diagram illustrating an example of a user interface 500 or web page that displays one or more members with jobs at the same organization and with similar roles to those of the job described in the job listing 520, and represents a continuation of FIG. 5A. and FIG. 5B.

In response to a user selecting the see similar members link 528 (FIG. 5B), the social networking system (e.g., system 120 in FIG. 1) displays one or more similar members (e.g., based on employer and job role). The member can then use information about the similar members to further gage whether the job represented by the job listing 520 is appropriate for them.

In this example, three similar members are displayed: Member 1 570, Member 2 572, and Member 3 574. In some example embodiments, the social networking system (e.g., system 120 in FIG. 1) determines whether there are any social connections between the requesting member (John Smith in this case) and any of the similar members. In this example, the social networking system (e.g., system 120 in FIG. 1) determines that the requesting member and Member 2 have a second degree connection 576 and causes a notification of the connection to be displayed to the requesting member. In this example, all three members have a similar role (e.g., ice sculptor or carver).

The user interface 500 also includes information in side sections of the user interface 500, including a contact recommendation section 508, a profile viewership statistic section 510, and a social graph statistic section 512.

FIG. 5D is a user interface diagram illustrating an example of a user interface 500 or web page that displays a list of skills associated with a job listing 520 and also an indication of whether each skill is missing, and represents a continuation of FIGS. 5A-5C.

In response to a user selecting the see skill analysis link 530 (FIG. 5B), the social networking system (e.g., system 120 in FIG. 1) displays one or more required skills for the job listing 520. Each skill (540-1 to 540-6) also includes an indication of whether that skill is lacking or not. In some example embodiments, skills that are possessed by the requesting member have a check mark (e.g., √), while those skills the requesting member lacks have an X.

In other example embodiments, skills receive either an X or a √ based on whether the members currently working for the source organization have those skills. For example, a skill that is lacking from the appropriate members/team currently employed by the source organization may be more highly prized in potential hiring candidates.

The user interface 500 also includes information in side sections of the user interface 500 including a contact recommendation section 508, a profile viewership statistic section 510, and a social graph statistic section 512.

FIG. 5E is a user interface diagram illustrating an example of a user interface 500 or web page that displays one or more likely co-workers based on the estimated role at the source organization, and represents a continuation of FIGS. 5A-5D.

In response to a user selecting the see likely co-workers link 532, the social networking system (e.g., system 120 in FIG. 1) displays one or more likely co-workers (e.g., based on information from the employer and stored in the job role). The member can then use information about the similar members to further gage whether the job represented by the job listing 520 is appropriate for them.

In this example, three similar members are displayed: Member 4 550, Member 5 552, and Member 6 554. In some example embodiments, the social networking system (e.g., system 120 in FIG. 1) determines whether there are any social connections between the requesting member (John Smith in this case) and any of the similar members. The user interface 500 also includes information in side sections of the user interface 500 including a contact recommendation section 508, a profile viewership statistic section 510, and a social graph statistic section 512.

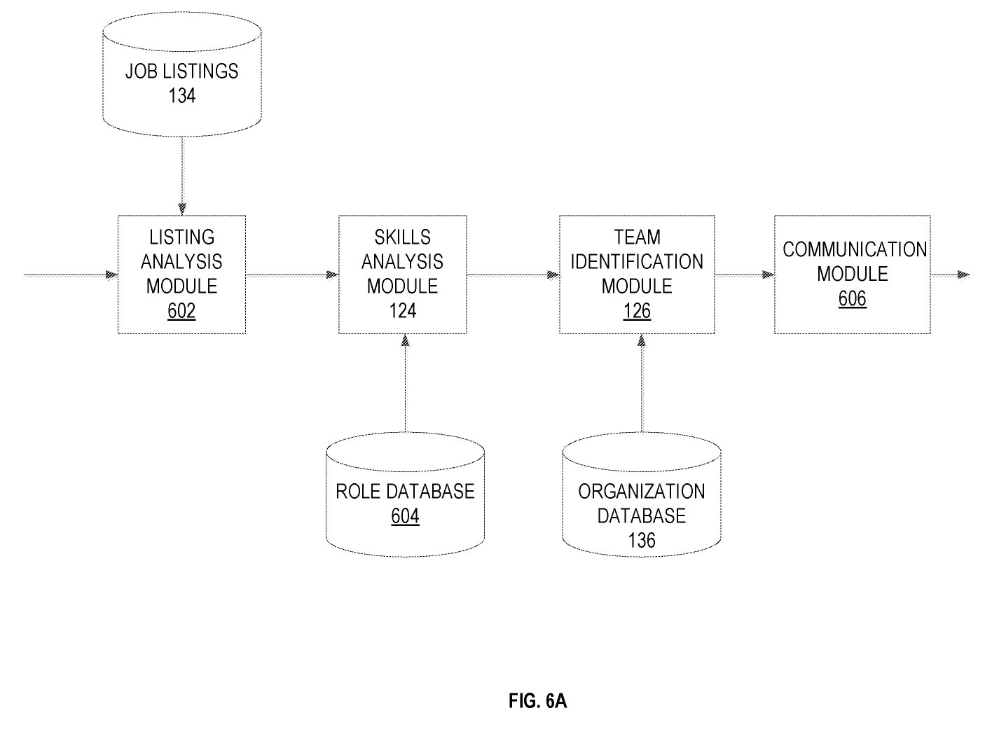

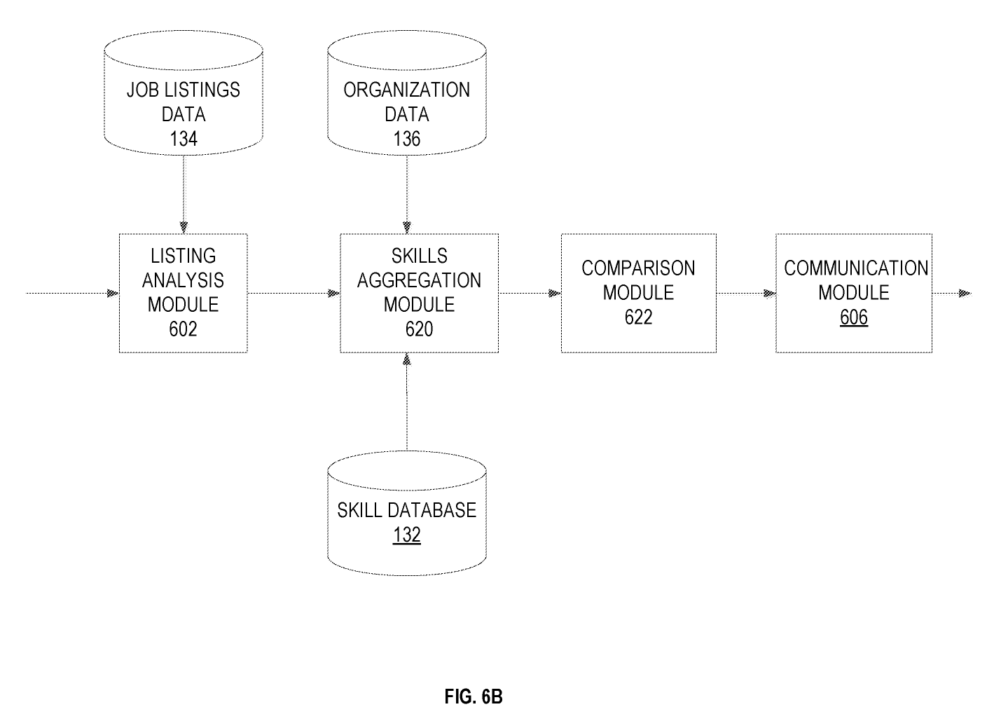

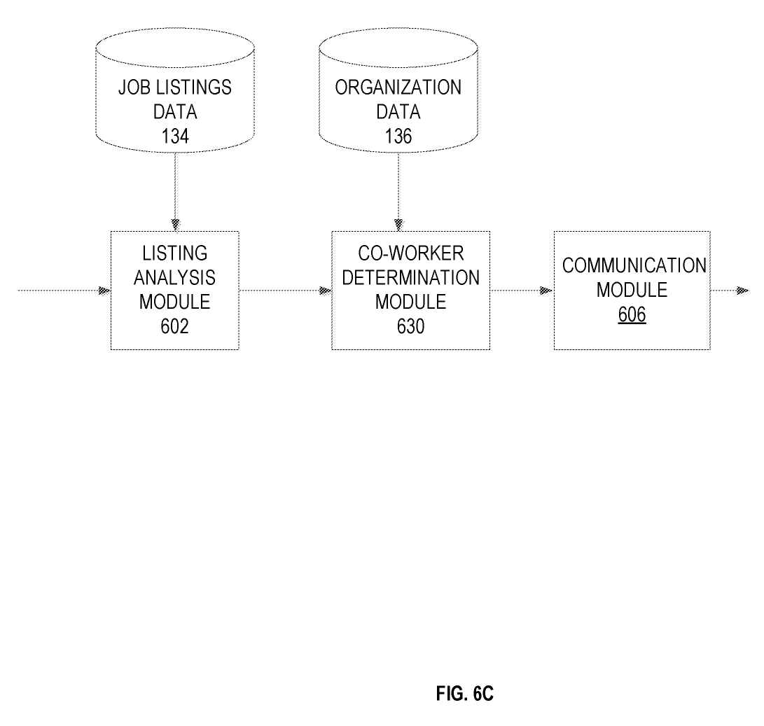

FIG. 6A is a block diagram illustrating a system for identifying members with employment roles in an organization similar to the role described in a job listing posted by the organization, in some example embodiments.

In some example embodiments, the social networking system (e.g., system 120 in FIG. 1) receives a job listing request from a client system (e.g., the client system 102 in FIG. 1). The job listing request identifies a particular job listing in the job listing data 134. In response, a listing analysis module 602 accesses the particular job listing from the job listing data 134. In some example embodiments, the listing analysis module 602 analyzes the job listing to identify one or more skills required or recommended for the job described in the particular job listing.

The listing analysis module 602 transmits the identified one or more skills to the skills analysis module 124. In some example embodiments, the skills analysis module 124 uses the list of skills to determine an employment role associated with the job described in the particular job listing. The potential employment roles are stored in a role database 604. For example, a job listing for a “web developer” that requires knowledge of HTML, CSS, Javascript, and so on, may be grouped in the employment role of “front-end developer.”

The team identification module 126 then uses the determined employment role associated with the job described in the particular job listing to identify one or more members who work at the organization associated with the particular job listing who fulfill a similar employment role. The list of members who work at a given organization can be generated based on a search of the organization data 136 or of the member profile data (e.g., the data 130 shown in FIG. 1). Continuing the above example, the team identification module 126 identifies other front-end developers who work at the same organization as the one that posted the particular job listing.

A communication module 606 then transmits or communicates the requested job listing and information about the one or more identified members who work at the same organization and whose employment role matches the role of the job listing.

FIG. 6B is a block diagram illustrating a system for identifying important skills that are missing from a particular group of members based on a reference list of skills, in some example embodiments.

In some example embodiments, a listing analysis module 602 receives a request for a specific job listing stored in the job listing data 134. Each job listing includes a list of requirements, responsibilities, and so on. The listing analysis module 602 determines the skills required or recommended for the job described in the job listing and uses those skills to identify the employment role that the job will be classified into.

The skills aggregation module 620 uses the determined employment role to identify one or more employees of the source organization of the specific job listing that have an employment role that matches the determined employment role for the job listing. The skills aggregation module 620 determines a list of skills for each identified employee from the skills database 132 of the source organization, determined by the organization data 138, that has the appropriate employment role.

In some example embodiments, the skills aggregation module 620 creates an aggregate list of all skills for all matching employees of the source organization. In some example embodiments, the aggregate list also records the relative frequency of the skills of the matching employees. For example, the aggregated skills list includes a list of skills, wherein each skill has an associated name or identifier and the percentage of matching employees that have the skill. In some example embodiments, skills that are shared by a large percentage of similar employees and are determined to be relevant to the employment role are deemed key skills.

In some example embodiments, a comparison module 622 compares the list of skills associated with the job listing (e.g., as determined by the listing analysis module 602) with the aggregated list of skills of matching employees. In this way, the comparison module 622 determines which skills required by or recommended for the job listing are not represented (e.g., missing) or underrepresented (e.g., a small percentage of matching employees have that skills).

In some example embodiments, the comparison module 622 determines a threshold percentage under which a skill will be determined to be underrepresented. Thus, the comparison module 622 determines, for each skill, whether the percentage of matching employees is below the threshold percentage.

In some example embodiments, the comparison module 622 determines a list of skills for the requesting member. The comparison module 622 can then compare the list of skills for the requesting member against the list of missing or underrepresented skills. Based on that comparison, the comparison module 622 determines one or more skills that the requesting member has that are missing or underrepresented at the associated organization.

In some example embodiments, the communication module 606 transmits the one or more skills that the requesting member has that are missing or underrepresented at the associated organization to the client system (e.g., the client system 102 in FIG. 1) for display.

FIG. 6C is a block diagram illustrating a system for identifying potential co-workers for a job described in a particular job listing, in some example embodiments.

In some example embodiments, a listing analysis module 602 receives a request for a specific job listing stored in the job listing data 134. Each job listing includes a list of requirements, responsibilities, an associated organization, and so on. The listing analysis module 602 determines whether there are any co-workers already associated with a particular job listing. For example, when the job listing is submitted, the submitter can choose one or more members of the social networking system (e.g., system 120 in FIG. 1) to associated with the specific job listing.

In accordance with a determination that there are one or more likely co-workers already attached to or otherwise associated with the particular job listing, the communication module 606 can transmit information associated with each likely co-worker to the requesting member.

In accordance with a determination that no likely co-workers have been associated with the particular job listing, a co-worker determination module 630 analyzes the information in the job listing, including job location, job title, job team, associated organization, job role, and job responsibilities and accesses the organization data 136 to identify one or more likely co-workers.

For example, if the job listing is for a job in an office that only has five other workers, the co-worker determination module 630 may infer that these five workers are the most likely co-workers associated with the job.

In another example, the job title is Lead of Concept Group at X Corporation. The co-worker determination module 630 may then determine that the job is likely associated with members in the Concept Group at X Corporation and will identify one or more members who match that description.

In some example embodiments, the communication module 606 then communicates the identified one or more likely co-workers to the client system (e.g., the client system 102 in FIG. 1) for display in a user interface associated with or provided by the social networking system (e.g., system 120 in FIG. 1).

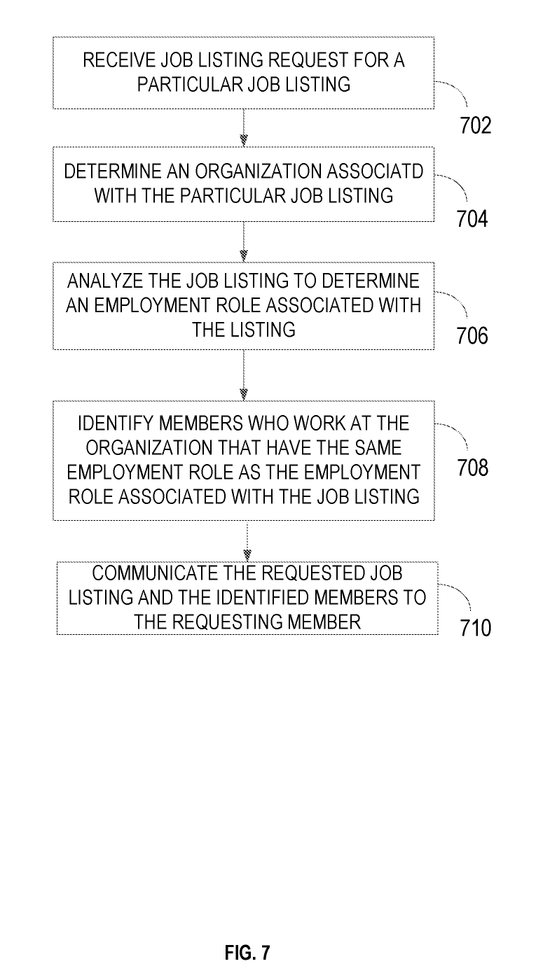

FIG. 7 is a flow diagram illustrating a method, in accordance with some example embodiments, for identifying members with employment roles in an organization similar to the role described in a job listing posted by the organization. Each of the operations shown in FIG. 7 may correspond to instructions stored in a computer memory (e.g., memory 306 in FIG. 3) or a computer-readable storage medium. In some example embodiments, the method described in FIG. 7 is performed by the social networking system (e.g., system 120 in FIG. 1).

In some example embodiments, the method is performed at a social networking system (e.g., system 120 in FIG. 1) including one or more processors and memory 306 storing one or more programs for execution by the one or more processors.

The social networking system (e.g., system 120 in FIG. 1) receives (702) a job listing request for a particular job listing stored in a job listing database (e.g., the job listing data 134 in FIG. 1). The social networking system (e.g., system 120 in FIG. 1) determines (704) an organization associated with the particular job listing. For example, the associated organization is the organization that posted the job listing or authorized it to be posted by a member.

The social networking system (e.g., system 120 in FIG. 1) analyzes (706) the job listing to determine an employment role associated with the particular job listing. For example, some job listings have specific skills associated with them at the time they are posted, such that all the required skills are connected to the job listing as metadata or displayed data. In other example embodiments, the social networking system (e.g., system 120 in FIG. 1) parses the text of the job listing to identify words or phrases associated with particular skills. The social networking system (e.g., system 120 in FIG. 1) also uses context including the type of organization that posted the job listing, the job title, and the job responsibilities to infer required skills.

Using information about the required skills and responsibilities, the social networking system (e.g., system 120 in FIG. 1) identifies an employment role associated with the particular job listing. Employment roles are more general categories of jobs that are useful for grouping jobs based on the work actually performed rather than the title. The social networking system (e.g., system 120 in FIG. 1) stores a plurality of employment role categories and rules for sorting a particular job into an employment role in a database that can then be accessed. In this way each job identified on the social networking system (e.g., system 120 in FIG. 1) can have an associated employment role that describes what general category of work the member who performs the job does or will do.

The social networking system (e.g., system 120 in FIG. 1) identifies (708) one or more members that work at the organization that posted the particular job listing that have the same employment role that is associated with the particular job listing. In this way, the social networking system (e.g., system 120 in FIG. 1) determines other employees at the same organization who have similar jobs to the job being advertised in the job listing.

The social networking system (e.g., system 120 in FIG. 1) then communicates (710) both the requested job listing and at least some information about the identified other members to the client system (e.g., the client system 102 in FIG. 1) associated with the requesting member.

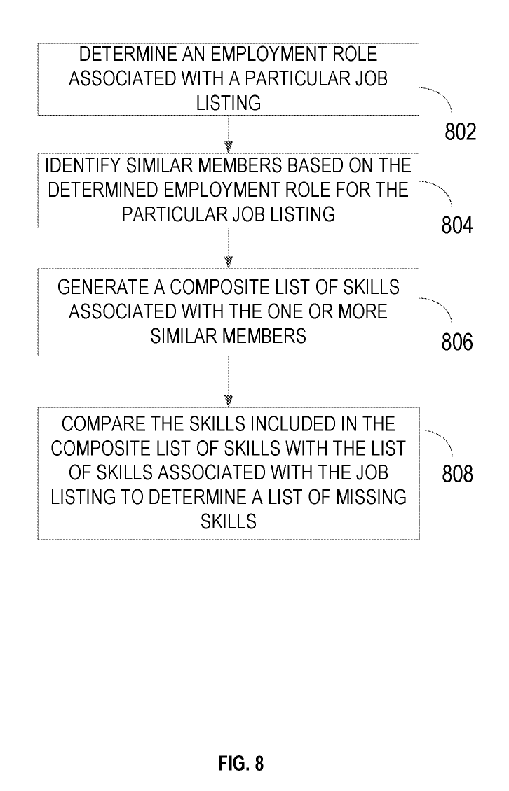

FIG. 8 is a flow diagram illustrating a method 800, in accordance with some example embodiments, for identifying skills missing from a group of members relative to a reference list of skills. Each of the operations shown in FIG. 8 may correspond to instructions stored in a computer memory or computer-readable storage medium. In some embodiments, the method 800 described in FIG. 8 is performed by the social networking system (e.g., system 120 in FIG. 1). However, the method 800 described can also be performed by any other suitable configuration of electronic hardware.

In some embodiments, the method 800 is performed at a social networking system (e.g., system 120 in FIG. 1) including one or more processors and memory storing one or more programs for execution by the one or more processors.

The social networking system (e.g., system 120 in FIG. 1) determines (802) an employment role associated with a particular job listing. For example, the particular job listing is a job listing for an ice sculptor. The social networking system (e.g., system 120 in FIG. 1) analyzes the required skills and determines an employment role to be “Ice Artist.” In some example embodiments, the employment role is determined based on an analysis of the job title, source organization, location, required skills, and responsibilities.

The social networking system (e.g., system 120 in FIG. 1) identifies (804) one or more similar members based on the determined employment role for the particular job listing and the similar members' association with the source organization. For example, if the identified employment role is full stack engineer and the source organization is pets.com, the social networking system (e.g., system 120 in FIG. 1) identifies one or more employees of pets.com whose employment role is determined to be full stack engineer.

In some example embodiments, the social networking system (e.g., system 120 in FIG. 1) generates (806) a composite list of skills associated with the one or more similar members. Thus, the composite list of skills includes all the relevant skills that each of the similar members have associated with their member profiles.

In some example embodiments, the social networking system (e.g., system 120 in FIG. 1) compares (808) the skills included in the composite list of skills with the list of skills associate with the particular job listing to determine a list of missing skills.

For example, the social networking system (e.g., system 120 in FIG. 1) compares the list of skills in the composite list of skills (representing all the skills that are available to current employees of the source organization) with the list of skills required by the job listing to determine whether any of the required skills are missing from the composite list of skills of the current employees (e.g., skills that would be highly desirable to the source organization).

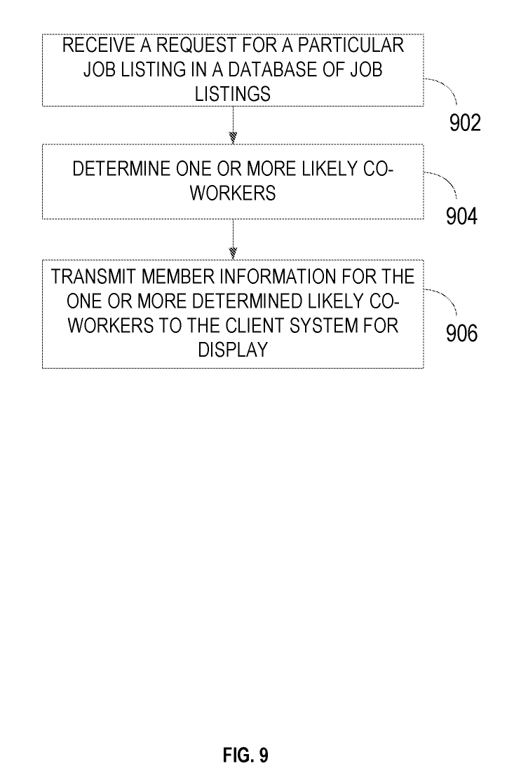

FIG. 9 is a flow diagram illustrating a method 900, in accordance with some example embodiments, for identifying potential co-workers for a job described in a particular job listing. Each of the operations shown in FIG. 9 may correspond to instructions stored in a computer memory or computer-readable storage medium. In some embodiments, the method 900 described in FIG. 9 is performed by the social networking system (e.g., system 120 in FIG. 1). However, the method 900 described can also be performed by any other suitable configuration of electronic hardware.

The social networking system (e.g., system 120 in FIG. 1) receives (902) a request for a particular job listing in a database of job listings. For example, a social networking system (e.g., system 120 in FIG. 1) stores a plurality of job listings that can be searched, viewed, selected, and responded to.

In some example embodiments, the social networking system (e.g., system 120 in FIG. 1) receives the request from a requesting member accessing the social networking system (e.g., system 120 in FIG. 1) over a computer network from a client system (e.g., the client system 102 in FIG. 1). The social networking system (e.g., system 120 in FIG. 1) prompts the member (e.g., though a link displayed in a user interface) to indicate whether the member would like to view potential co-workers for a particular job.

In accordance with a determination that the member selects (e.g., by clicking on the presented link) to view information associated with likely co-workers, the social networking system (e.g., system 120 in FIG. 1) determines (904) one or more likely co-workers for the job described in the particular job listing.

In some example embodiments, determining likely co-workers is accomplished by determining whether the job listing has determined likely co-workers (e.g., members who were designated at the time the job listing was submitted to the social networking system). If not, the social networking system (e.g., system 120 in FIG. 1) uses information about the job listing, job title, responsibilities, compensation, and so on to identify one or more likely co-workers.

In some example embodiments, the social networking system (e.g., system 120 in FIG. 1) then transmits (906) member information for the one or more identified likely co-workers to the client system (e.g., the client system 102 in FIG. 1) for display.

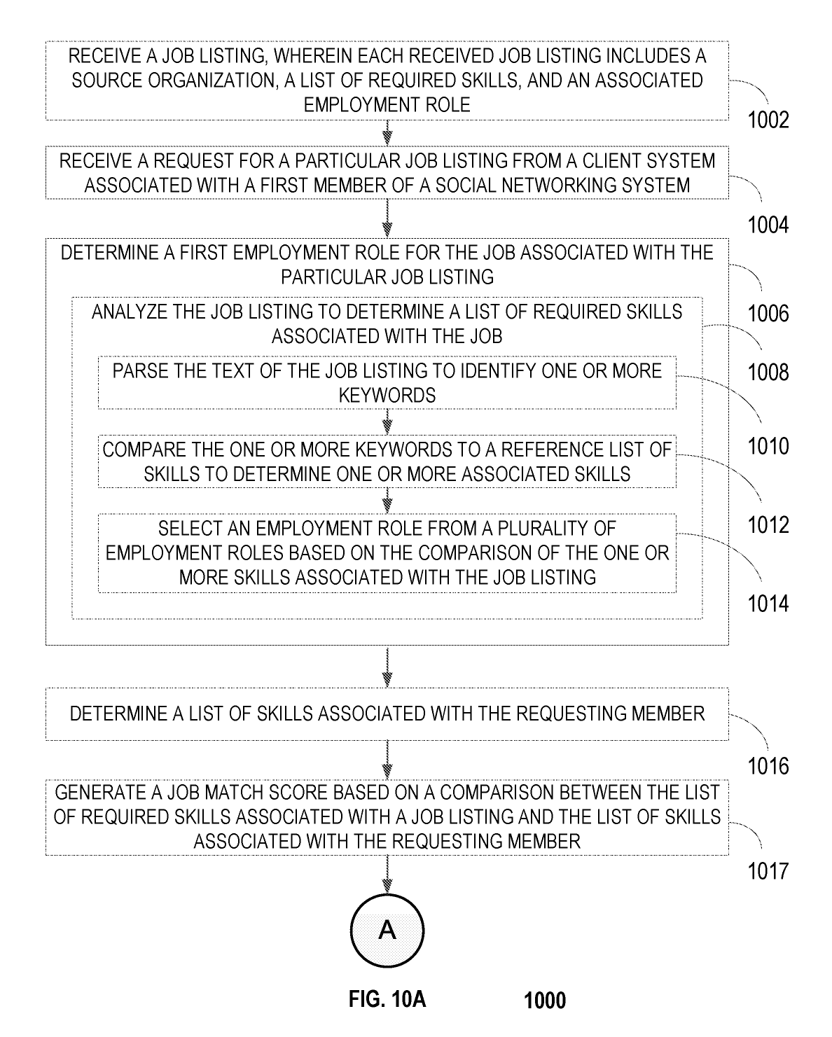

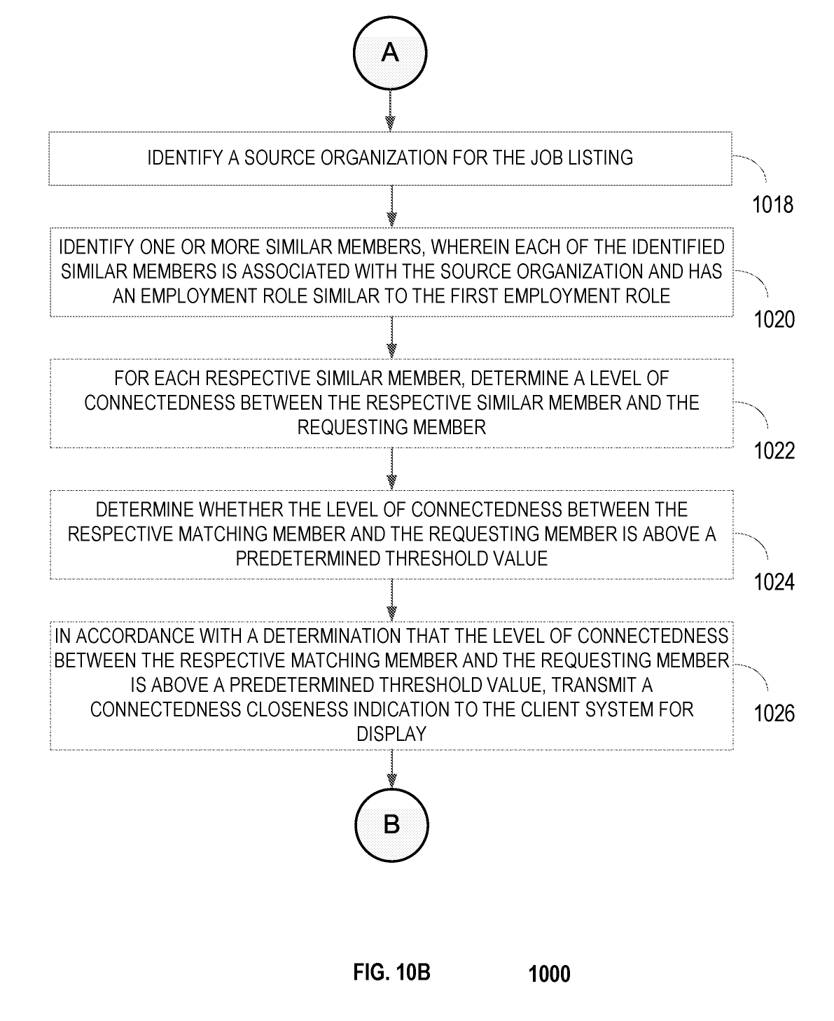

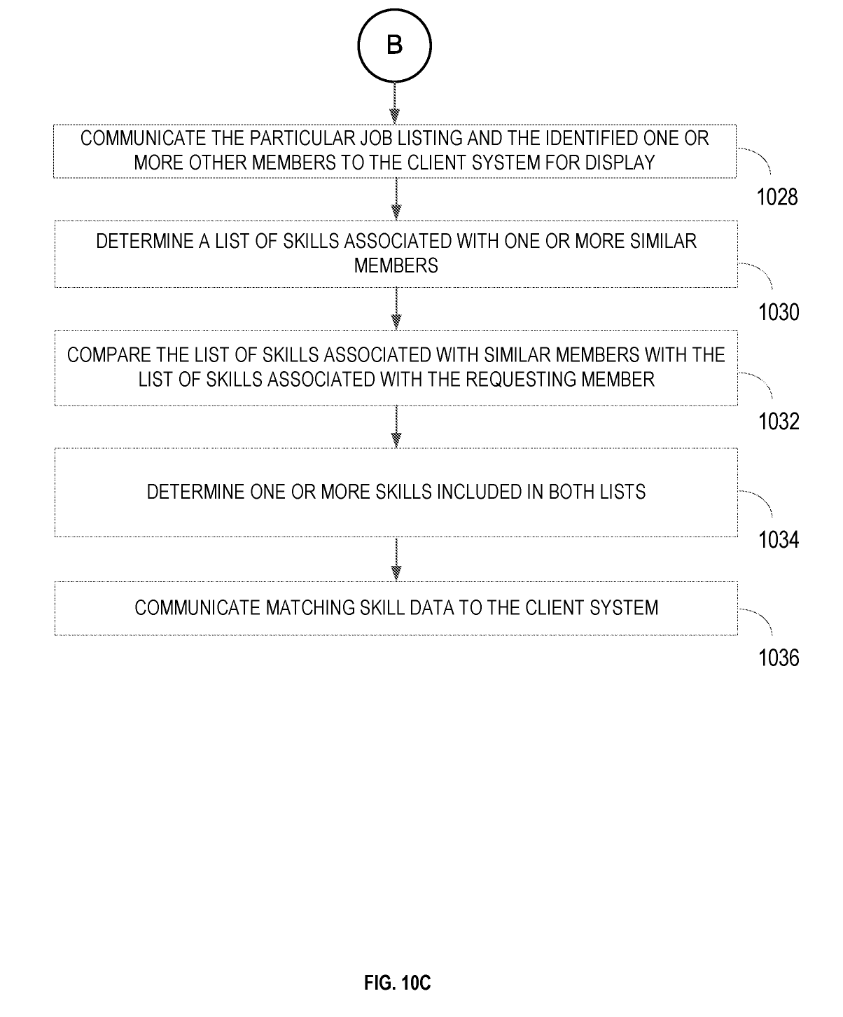

FIG. 10A is a flow diagram illustrating a method 1000, in accordance with some example embodiments, for identifying members with employment roles in an organization similar to the role described in a job listing posted by the organization. Each of the operations shown in FIG. 10A may correspond to instructions stored in a computer memory or computer-readable storage medium. Optional operations are indicated by dashed lines (e.g., boxes with dashed-line borders). In some embodiments, the method 1000 described in FIG. 10A is performed by the social networking system (e.g., system 120 in FIG. 1). However, the method 1000 described can also be performed by any other suitable configuration of electronic hardware.

In some embodiments, the method 1000 is performed at a social networking system (e.g., system 120 in FIG. 1) including one or more processors and memory storing one or more programs for execution by the one or more processors.

The social networking system (e.g., system 120 in FIG. 1) receives (1002) a job listing, wherein each received job listing includes a source organization, a list of required skills, and an associated employment role. Each job listing is then stored in a job listing database available to be searched by members of the social networking system (e.g., system 120 in FIG. 1) though a user interface provided by the social networking system (e.g., system 120 in FIG. 1).

A member then browses or searches the database of job listings. When the member wishes to see a particular job listing, the member causes a request to be sent to the social networking system (e.g., system 120 in FIG. 1).

The social networking system (e.g., system 120 in FIG. 1) receives (1004) a request for a particular job listing from a client system (e.g., the client system 102 in FIG. 1) associated with a first member of a social networking system. The request includes information identifying the particular job listing that is being requested.

The social networking system (e.g., system 120 in FIG. 1) determines (1006) a first employment role for the job associated with the particular job listing. An employment role is a general category of job based on each job's responsibilities and duties, rather than the job's specific title. These employment role designations are used to group similar jobs together even when the titles of the two jobs are different.

To determine an employment role for a particular job listing, the social networking system (e.g., system 120 in FIG. 1) analyzes (1008) the job listing to determine a list of required skills associated with the job. In some example embodiments, a job listing includes one or more required skills that are explicitly stated or were included in a format that was able to be automatically included in the information associated with the job listing.

In some example embodiments, the social networking system (e.g., system 120 in FIG. 1) first determines whether there are any predetermined skills already associated with a particular job listing. If not, the social networking system (e.g., system 120 in FIG. 1) then identifies one or more required or recommended skills based on the job listing data.

In some example embodiments, analyzing a job listing to determine a list of required skills for the job includes parsing (1010) the text of the job listing to identify one or more keywords or phrases. The social networking system (e.g., system 120 in FIG. 1) then compares (1012) the one or more keywords to a reference list of skills to determine one or more associated skills. For example, if the text of the job listing includes the phrase “website design” the social networking system (e.g., system 120 in FIG. 1) may determine that the position requires CSS skills based on keyword or phrase association.

Based on the determined list of required skills, the social networking system (e.g., system 120 in FIG. 1) selects (1014) an employment role from a plurality of employment roles. For example, the social networking system (e.g., system 120 in FIG. 1) includes a database of employment roles, including rules or guidelines for determining which employment roles a particular job should be grouped into. Each job is then assigned to one or more employment role “buckets” based on skill matching to determine which employment role includes the largest number of essential skills. In other example embodiments, the social networking system (e.g., system 120 in FIG. 1) uses statistical analysis tools to sort jobs into employment role buckets. For example, this can be accomplished through the use of a classifier.

In some example embodiments, the job listings are grouped into specific roles when the jobs are submitted to the social networking system (e.g., system 120 in FIG. 1). Thus, prior to analyzing the required skills, the social networking system (e.g., system 120 in FIG. 1) can determine whether an employment role is already associated with a particular job listing.

In other example embodiments, the social networking system (e.g., system 120 in FIG. 1) uses additional information such as job title, industrial area of the organization, compensation, experience, team name, and such to help group the job into the best employment role.

In some example embodiments, the social networking system (e.g., system 120 in FIG. 1) determines (1016) a list of skills associated with the requesting member. In some example embodiments, the social networking system (e.g., system 120 in FIG. 1) determines whether the member profile of the requesting member has an existing list of skills, including both explicitly stated skills and implicitly inferred skills. In accordance with a determination that the member profile of the requesting member does not include an existing list of skills, the social networking system (e.g., system 120 in FIG. 1) analyzes the member profile of the member to generate a list of skills that the requesting member has.

The social networking system (e.g., system 120 in FIG. 1) generates (1017) a job match score based on a comparison between the list of required skills associated with a job listing and the list of skills associated with the requesting member. For example, a member that has a large overlap between the member's skills and the required skills for the job listing would have a higher job match score than a member with fewer skills that matched the list of required skills.

FIG. 10B is a flow diagram illustrating a method 1000, in accordance with some example embodiments, for identifying members with employment roles in an organization similar to the role described in a job listing posted by the organization. Each of the operations shown in FIG. 10B may correspond to instructions stored in a computer memory or computer-readable storage medium. Optional operations are indicated by dashed lines (e.g., boxes with dashed-line borders). In some embodiments, the method 1000 described in FIG. 10B is performed by the social networking system (e.g., system 120 in FIG. 1). However, the method 1000 described can also be performed by any other suitable configuration of electronic hardware.

In some embodiments, the method 1000 is performed at a social networking system (e.g., system 120 in FIG. 1) including one or more processors and memory storing one or more programs for execution by the one or more processors.

The social networking system (e.g., system 120 in FIG. 1) identifies (1018) a source organization for the job listing. For example, when each job listing is submitted to the social networking system (e.g., system 120 in FIG. 1), the submitter includes information identifying the organization associated with the job. In some example embodiments, only authorized members can submit job listings for particular organizations. Thus, when a user attempts to submit a job listing associated with a specific organization, the social networking system (e.g., system 120 in FIG. 1) determines whether the submitting member is pre-approved by the specific organization to submit job listings on its behalf.

The social networking system (e.g., system 120 in FIG. 1) identifies (1020) one or more similar members, wherein each of the identified similar members is associated with the source organization and has an employment role similar to the first employment role. For example, the social networking system (e.g., system 120 in FIG. 1) may use the employment role for the job listing, the industrial area of the source organization, and the required skills to identify any members at the source organization that have the same basic role at the source organization.

For each respective similar member, the social networking system (e.g., system 120 in FIG. 1) determines (1022) a level of connectedness between the respective similar member and the requesting member. For example, for each matching member identified, the social networking system (e.g., system 120 in FIG. 1) computes a level of connectedness based on the number of connections needed to connect the two members through the social graph, the number of common connections, and other factors.

In some example embodiments, the social networking system (e.g., system 120 in FIG. 1) determines (1024) whether the level of connectedness between the respective matching member and the requesting member is above a predetermined threshold value. For example, if the level of connectedness between two members is given a score between 1 and 0 (wherein 1 represents a direct connection and a high number of common contacts and 0 is absolutely no connection), the social networking system (e.g., system 120 in FIG. 1) determines a threshold value that serves to determine whether or not to inform the requesting member about the connection between the requesting member and the respective matching member. In this way, when a connection between members is likely irrelevant to either member, no notice is displayed.

In accordance with a determination that the level of connectedness between the respective matching member and the requesting member is above a predetermined threshold value, the social networking system (e.g., system 120 in FIG. 1) transmits (1026) a connectedness closeness indication to the client system (e.g., the client system 102 in FIG. 1) for display.

FIG. 10C is a flow diagram illustrating a method 1000, in accordance with some example embodiments, for identifying members with employment roles in an organization similar to the role described in a job listing posted by the organization. Each of the operations shown in FIG. 10C may correspond to instructions stored in a computer memory or computer-readable storage medium. Optional operations are indicated by dashed lines (e.g., boxes with dashed-line borders). In some embodiments, the method 1000 described in FIG. 10C is performed by the social networking system (e.g., system 120 in FIG. 1). However, the method 1000 described can also be performed by any other suitable configuration of electronic hardware.

In some embodiments, the method 1000 is performed at a social networking system (e.g., system 120 in FIG. 1) including one or more processors and memory storing one or more programs for execution by the one or more processors.

In some example embodiments, the social networking system (e.g., system 120 in FIG. 1) communicates (1028) the particular job listing and the identified one or more other members to the client system (e.g., the client system 102 in FIG. 1) for display.

In some example embodiments, the social networking system (e.g., system 120 in FIG. 1) only transmits the one or more other members to the client system (e.g., the client system 102 in FIG. 1) if the requesting member specifically requests this information (e.g., by clicking a link or other means). Thus, the social networking system (e.g., system 120 in FIG. 1) first determines whether the requesting member has requested information about similar members. In accordance with a determination that the member has not requested such information, the social networking system (e.g., system 120 in FIG. 1) only sends the requested job listing to the client system (e.g., the client system 102 in FIG. 1) for display.

In some example embodiments, the social networking system (e.g., system 120 in FIG. 1) determines (1030) a list of skills associated with one or more similar members. Thus, the social networking system (e.g., system 120 in FIG. 1) retrieves a list of all skills associated with the one or more similar members and aggregates them into a single skill list. In some example embodiments, the social networking system (e.g., system 120 in FIG. 1) only includes skills that are relevant to the employment roles that are associated with the group of similar members and the particular job listing.

In some example embodiments, the social networking system (e.g., system 120 in FIG. 1) compares (1032) the list of skills associated with the similar members with the list of skills associated with the requesting member. For example, the system determines which of the requesting member's skills is also included in the aggregated group of similar members' skills. In other example embodiments, the social networking system (e.g., system 120 in FIG. 1) determines whether the requesting member has the most common skills among the similar members.

In some example embodiments, the social networking system (e.g., system 120 in FIG. 1) determines (1034) one or more skills included in both the aggregated similar member's skill list and the requesting members' skill list. Matching the two lists is used to estimate the degree to which the requesting member would be a good fit in the employment role represented by the job listing.

In some example embodiments, the social networking system (e.g., system 120 in FIG. 1) communicates (1036) matching skill data to the client system (e.g., the client system 102 in FIG. 1). In some example embodiments, this matching skill data is only transmitted to the client system (e.g., the client system 102 in FIG. 1) in accordance with a specific request from the requesting member.

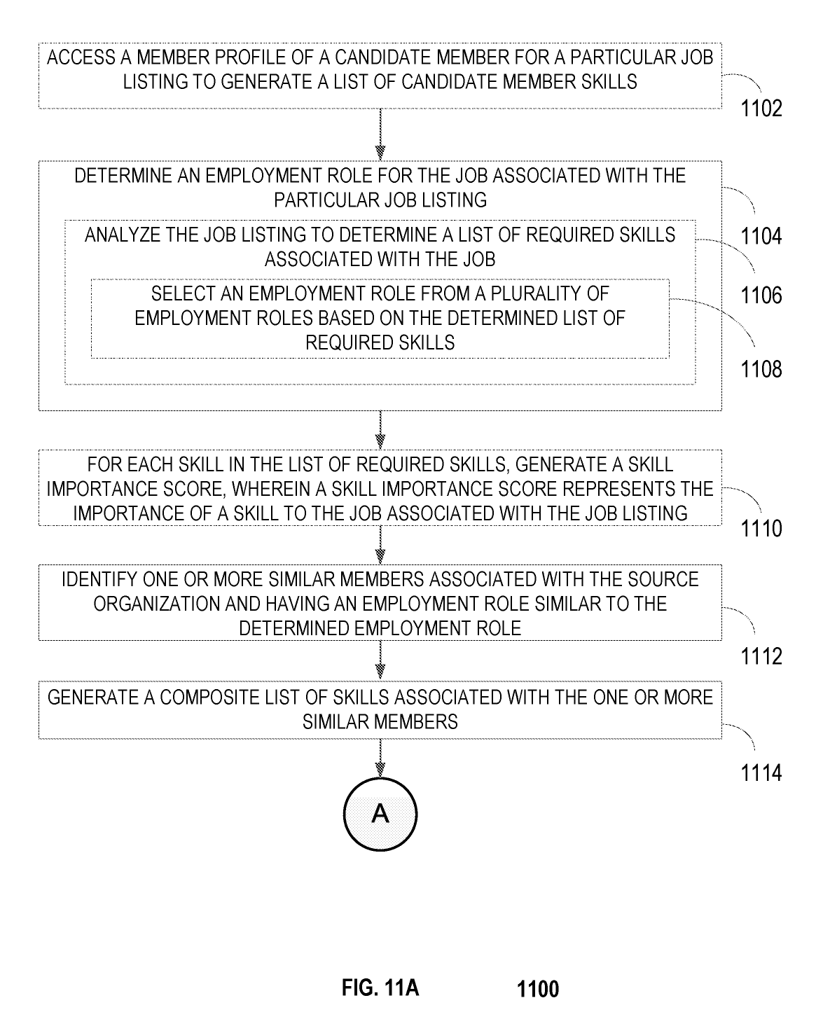

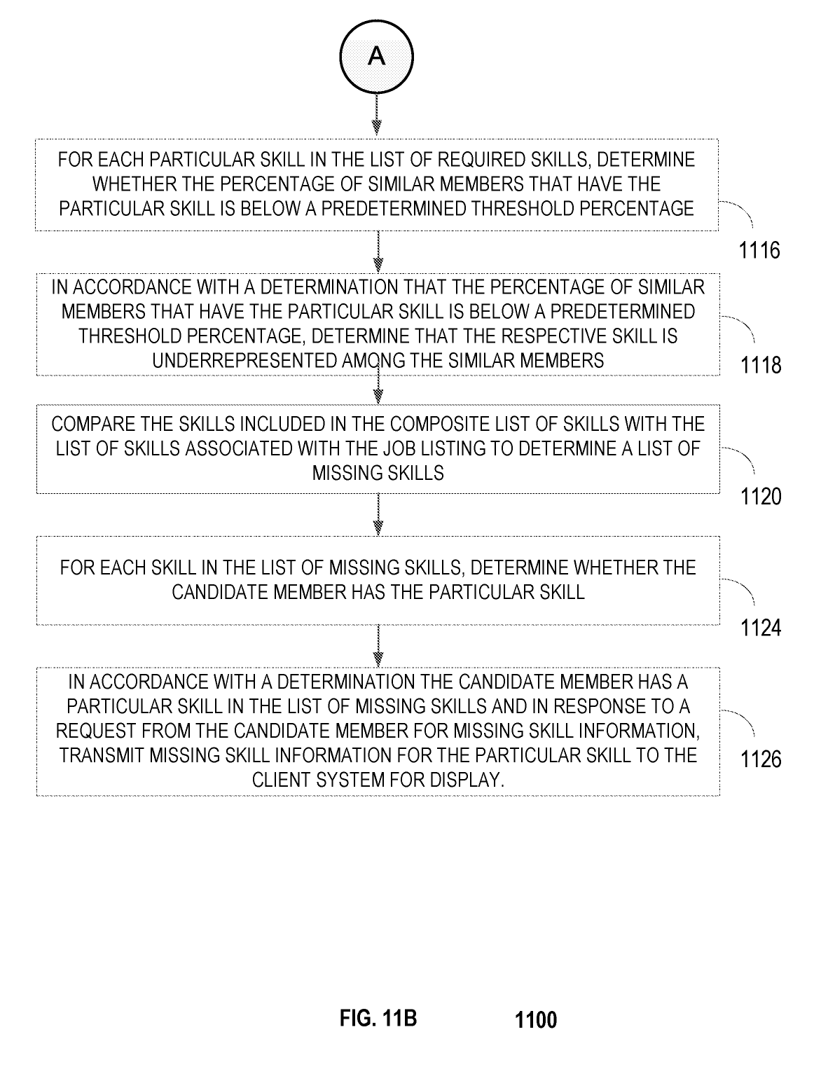

FIG. 11A is a flow diagram illustrating a method 1100, in accordance with some example embodiments, for identifying skills missing from a group of members relative to a reference list of skills. Each of the operations shown in FIG. 11A may correspond to instructions stored in a computer memory or computer-readable storage medium. Optional operations are indicated by dashed lines (e.g., boxes with dashed-line borders). In some embodiments, the method 1100 described in FIG. 11A is performed by the social networking system (e.g., system 120 in FIG. 1). However, the method 1100 described can also be performed by any other suitable configuration of electronic hardware.

In some embodiments, the method 1100 is performed at a social networking system (e.g., system 120 in FIG. 1) including one or more processors and memory storing one or more programs for execution by the one or more processors.

In some example embodiments, the social networking system (e.g., system 120 in FIG. 1) receives a job listing request from a candidate member for a particular job listing. In response, the social networking system (e.g., system 120 in FIG. 1) accesses (1102) a member profile of the candidate member for the particular job listing to generate a list of candidate member skills. In some example embodiments, the member profiles are stored at a member profile data store (e.g., the member profile data 130 in FIG. 1) at the social networking system (e.g., system 120 in FIG. 1).

The social networking system (e.g., system 120 in FIG. 1) determines (1104) an employment role for the job associated with the particular job listing. An employment role is a general category of job based on each job's responsibilities and duties, rather than the job's specific title. These employment role designations are used to group similar jobs together even when the titles of the two jobs are different.

To determine an employment role for a particular job listing, the social networking system (e.g., system 120 in FIG. 1) analyzes (1106) the job listing to determine a list of required skills associated with the job. In some example embodiments, a job listing includes one or more required skills that are explicitly stated and available in metadata or another accessible data form.

In some example embodiments, the social networking system (e.g., system 120 in FIG. 1) then selects (1108) an employment role from a plurality of potential employment roles based on the determined list of required skills.

For each skill in the list of required skills, the social networking system (e.g., system 120 in FIG. 1) generates (1110) a skill importance score, wherein the skill importance score represents the importance of a skill to the job associated with the job listing. For example, if a particular skill is mentioned several times in a job listing or receives extra emphasis in the wording, that skill will receive a higher skill importance score than a skill that is mentioned once, only in passing, or with little emphasis.

The social networking system (e.g., system 120 in FIG. 1) identifies (1112) one or more similar members associated with the source organization and having an employment role similar to the determined employment role. For example, the social networking system (e.g., system 120 in FIG. 1) identifies all welders at a construction company.

In some example embodiments, the social networking system (e.g., system 120 in FIG. 1) generates (1114) a composite list of skills associated with the one or more similar members. The composite list of skills includes, for each particular listed skill, the number of similar members in the one or more similar members who have the particular skill. In some example embodiments, the composite skills list also ranks the skills in order of skill importance.

FIG. 11B is a flow diagram illustrating a method 1100, in accordance with some example embodiments, for identifying skills missing from a group of members relative to a reference list of skills. Each of the operations shown in FIG. 11B may correspond to instructions stored in a computer memory or computer-readable storage medium. Optional operations are indicated by dashed lines (e.g., boxes with dashed-line borders). In some embodiments, the method 1100 described in FIG. 11B is performed by the social networking system (e.g., system 120 in FIG. 1). However, the method 1100 described can also be performed by any other suitable configuration of electronic hardware.

In some embodiments, the method 1100 is performed at a social networking system (e.g., system 120 in FIG. 1) including one or more processors and memory storing one or more programs for execution by the one or more processors.

For each particular skill in the list of required skills, the social networking system (e.g., system 120 in FIG. 1) determines (1116) whether the percentage of similar members that have the particular skill is below a predetermined threshold percentage. For example, if the percentage of similar workers who have Skill A is 33 percent (e.g., three of nine similar members have Skill A), the social networking system (e.g., system 120 in FIG. 1) compares that percentage against the threshold percentage value (e.g., 25 percent) and determines that the percentage for Skill A is above the threshold percentage.

In accordance with a determination that the percentage of similar members that have the particular skill is below the predetermined threshold percentage, the social networking system (e.g., system 120 in FIG. 1) determines (1118) that the respective skill is underrepresented among the similar members.

The social networking system (e.g., system 120 in FIG. 1) compares (1120) the skills included in the composite list of skills with the list of skills associated with the job listing to determine a list of missing skills. For example, the required skill list includes skills A, B, C, D, and E. The composite list of skills includes skills B, C, and E, but not A and D. The social networking system (e.g., system 120 in FIG. 1) determines that skills A and D are missing.

In another example, the composite list of skills includes all five skills, but two of the skills, A and C, are found in less than ten percent of the similar members. Thus, skills A and C are determined to be underrepresented.

In some example embodiments, for each skill in the list of missing or underrepresented skills, the social networking system (e.g., system 120 in FIG. 1) determines (1124) whether the candidate member has the particular skill. In accordance with a determination that the candidate member has a particular skill in the list of missing skills and in response to a request from the candidate member for missing skill information, the social networking system (e.g., system 120 in FIG. 1) transmits (1126) missing skill information for the particular skill to the client system (e.g., the client system 102 in FIG. 1) for display.

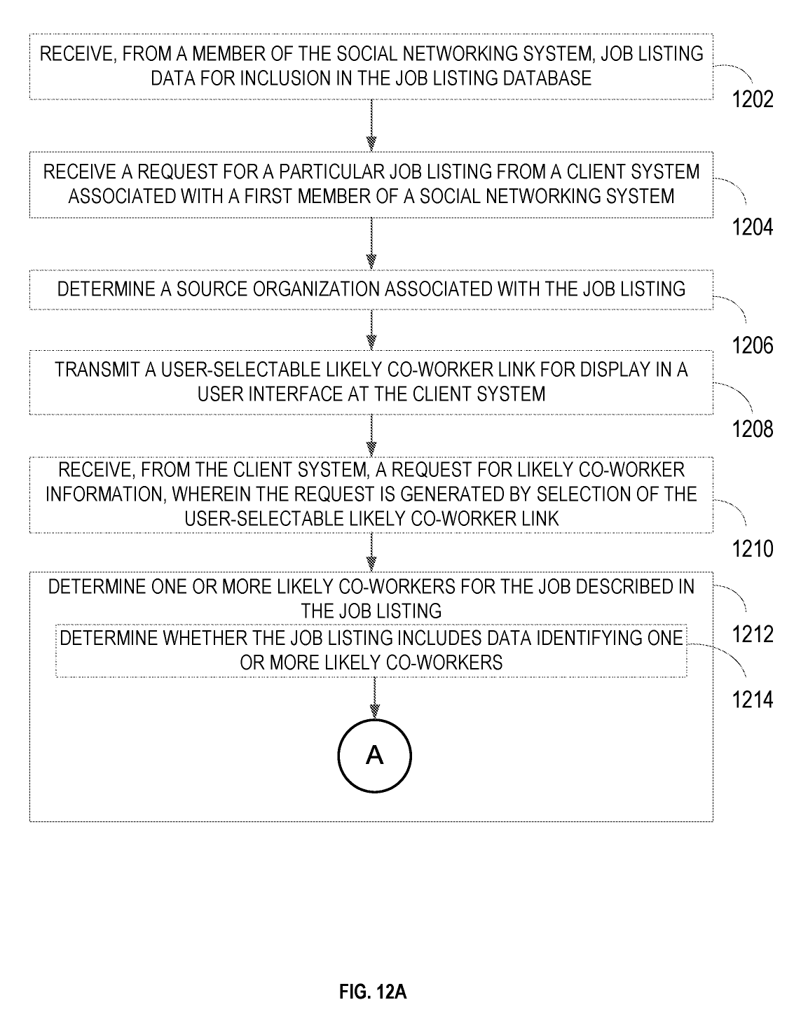

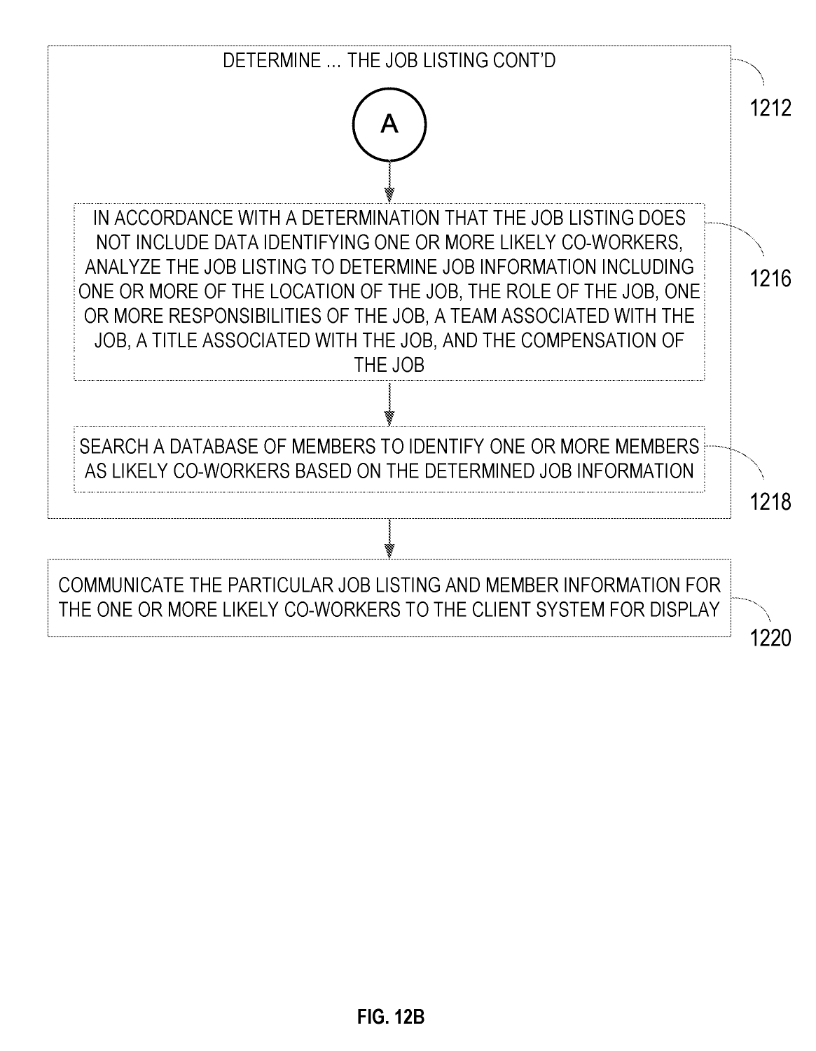

FIG. 12A is a flow diagram illustrating a method 1200, in accordance with some example embodiments, for identifying potential co-workers for a job described in a particular job listing. Each of the operations shown in FIG. 12A may correspond to instructions stored in a computer memory or computer-readable storage medium. Optional operations are indicated by dashed lines (e.g., boxes with dashed-line borders). In some embodiments, the method 1200 described in FIG. 12A is performed by the social networking system (e.g., system 120 in FIG. 1). However, the method 1200 described can also be performed by any other suitable configuration of electronic hardware.

In some embodiments, the method 1200 is performed at a social networking system (e.g., system 120 in FIG. 1) including one or more processors and memory storing one or more programs for execution by the one or more processors.

The social networking system (e.g., system 120 in FIG. 1) receives (1202), from a member of the social networking system, job listing data for inclusion in the job listing database. In some example embodiments, an organization will submit a job listing for inclusion in the database of job listings stored at the social networking system (e.g., system 120 in FIG. 1). In some example embodiments, the job listing data includes one or more selected likely co-workers.

For example, Member A is a manager of a team at Corporation N and needs to hire a new graphic designer. Member A submits a job listing to the social networking system (e.g., system 120 in FIG. 1) describing the job requirements and selects one or more other members as likely co-workers, based on Member A's assessment of the members who will work most closely with the newly hired employee.

In some example embodiments, the social networking system (e.g., system 120 in FIG. 1) receives (1204) a request for a particular job listing from a client system associated with a first member of the social networking system. In some example embodiments, the job listing request is received from the first member after an initial response to the member for an activity feed or other web page and that web page included a link to one or more job listings.

In some example embodiments, the social networking system (e.g., system 120 in FIG. 1) determines (1206) a source organization associated with the job listing. For example, a job listing may include a source organization (e.g., the organization that is posting the job). In some example embodiments, not every job listing lists a source organization (e.g., hiring by an individual rather than an organization). As such, the social networking system (e.g., system 120 in FIG. 1) determines whether a particular job listing has an associated source organization.

In some example embodiments, the social networking system (e.g., system 120 in FIG. 1) transmits (1208) a user-selectable likely co-worker link for display in a user interface at the client system. In some example embodiments, the user-selectable likely co-worker link is included in a web page that includes the selected job listing.

In some example embodiments, the social networking system (e.g., system 120 in FIG. 1) receives (1210), from the client system, a request for likely co-worker information, wherein the request is generated by selection of the user-selectable likely co-worker link.

In some example embodiments, the social networking system (e.g., system 120 in FIG. 1) determines (1212) one or more likely co-workers for the job described in the job listing.

In some example embodiments, determining one or more likely co-workers for the job described in the job listing includes the social networking system (e.g., system 120 in FIG. 1) determining (1214) whether the job listing includes data identifying one or more likely co-workers.

FIG. 12B is a flow diagram illustrating a method 1200, in accordance with some example embodiments, for identifying potential co-workers for a job described in a particular job listing. Each of the operations shown in FIG. 12B may correspond to instructions stored in a computer memory or computer-readable storage medium. Optional operations are indicated by dashed lines (e.g., boxes with dashed-line borders). In some embodiments, the method 1200 described in FIG. 12B is performed by the social networking system (e.g., system 120 in FIG. 1). However, the method 1200 described can also be performed by any other suitable configuration of electronic hardware.

In some embodiments, the method 1200 is performed at a social networking system (e.g., system 120 in FIG. 1) including one or more processors and memory storing one or more programs for execution by the one or more processors.

In accordance with a determination that the job listing does not include data identifying one or more likely co-workers, the social networking system (e.g., system 120 in FIG. 1) analyzes (1216) the job listing to determine job information including one or more of the location of the job, the role of the job, one or more responsibilities of the job, a team associated with the job, a title associated with the job, and the compensation of the job.

In some example embodiments, the social networking system (e.g., system 120 in FIG. 1) searches (1218) a database of members to identify one or more members as likely co-workers based on the determined job information.

In some example embodiments, the social networking system (e.g., system 120 in FIG. 1) communicates (1220) the particular job listing and member information for the one or more likely co-workers to the client system (e.g., the client system 102 in FIG. 1) for display.

### Software Architecture

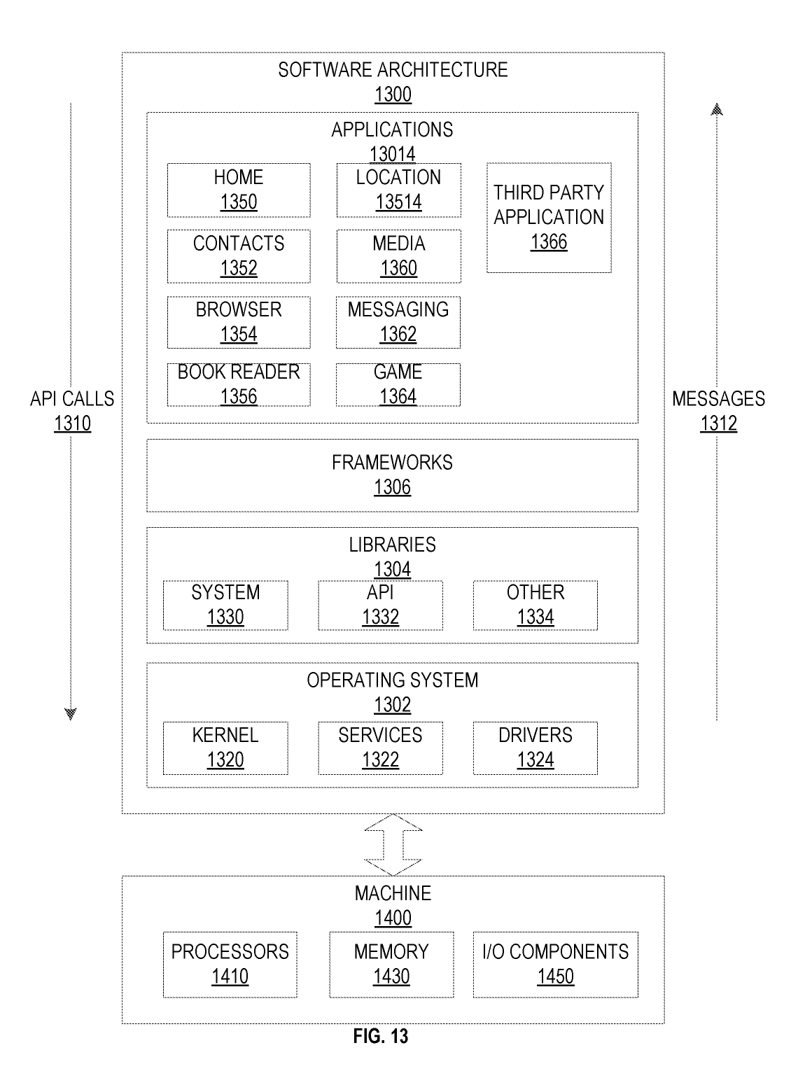

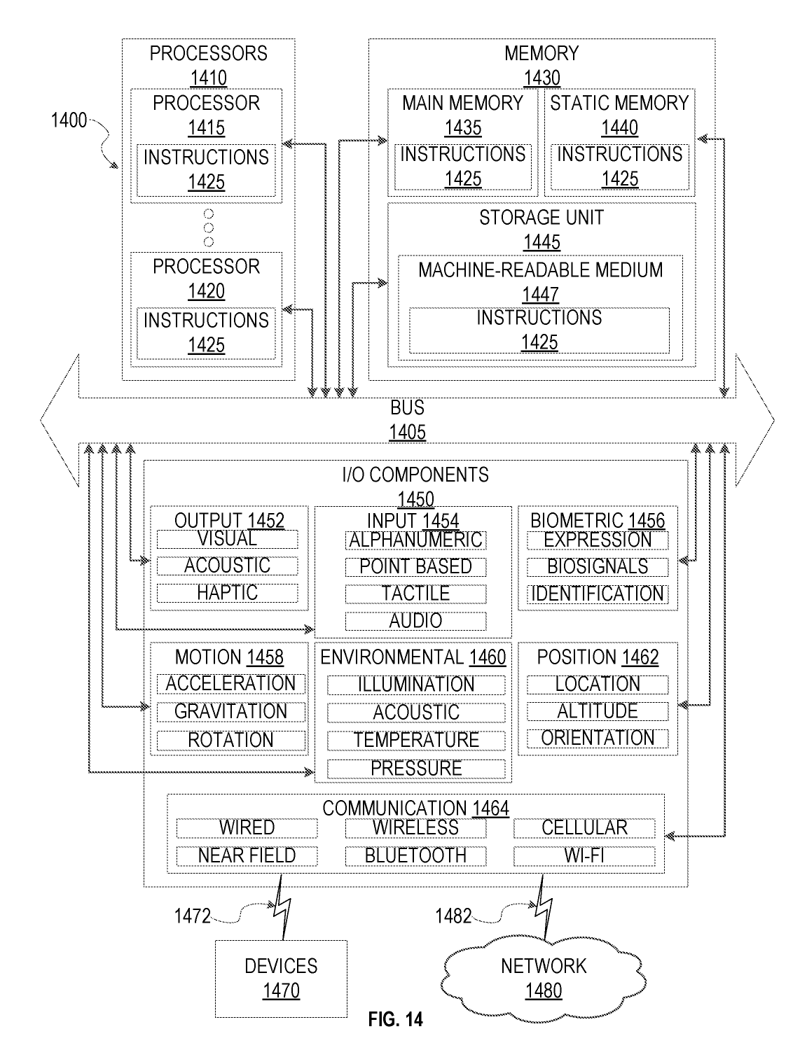

FIG. 13 is a block diagram illustrating an architecture of software 1300, which may be installed on any one or more of the devices of FIG. 1. FIG. 13 is merely a non-limiting example of an architecture of software 1300, and it will be appreciated that many other architectures may be implemented to facilitate the functionality described herein. The software 1300 may be executing on hardware such as a machine 1400 of FIG. 14 that includes processors 1410, memory 1430, and I/O components 1450. In the example architecture of FIG. 13, the software 1300 may be conceptualized as a stack of layers where each layer may provide particular functionality. For example, the software 1300 may include layers such as an operating system 1302, libraries 1304, frameworks 1306, and applications 1309. Operationally, the applications 1309 may invoke API calls 1310 through the software stack and receive messages 1312 in response to the API calls 1310.

The operating system 1302 may manage hardware resources and provide common services. The operating system 1302 may include, for example, a kernel 1320, services 1322, and drivers 1324. The kernel 1320 may act as an abstraction layer between the hardware and the other software layers. For example, the kernel 1320 may be responsible for memory management, processor management (e.g., scheduling), component management, networking, security settings, and so on. The services 1322 may provide other common services for the other software layers. The drivers 1324 may be responsible for controlling and/or interfacing with the underlying hardware. For instance, the drivers 1324 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 1304 may provide a low-level common infrastructure that may be utilized by the applications 1309. The libraries 1304 may include system libraries 1330 (e.g., C standard library) that may provide functions such as memory allocation functions, string manipulation functions, mathematic functions, and the like. In addition, the libraries 1304 may include API libraries 1332 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1304 may also include a wide variety of other libraries 1334 to provide many other APIs to the applications 1309.

The frameworks 1306 may provide a high-level common infrastructure that may be utilized by the applications 1309. For example, the frameworks 1306 may provide various graphical user interface (GUI) functions, high-level resource management, high-level location services, and so forth. The frameworks 1306 may provide a broad spectrum of other APIs that may be utilized by the applications 1309, some of which may be specific to a particular operating system 1302 or platform.

The applications 1309 include a home application 1350, a contacts application 1352, a browser application 1354, a book reader application 1356, a location application 1359, a media application 1360, a messaging application 1362, a game application 1364, and a broad assortment of other applications such as a third party application 1366. In a specific example, the third party application 1366 (e.g., an application developed using the Android™ or iOS™ software development kit (SDK) by an entity other than the vendor of the particular platform) may be mobile software running on a mobile operating system 1302 such as iOS™ Android™, Windows® Phone, or other mobile operating systems 1302. In this example, the third party application 1366 may invoke the API calls 1310 provided by the mobile operating system 1302 to facilitate functionality described herein.

### Example Machine Architecture and Machine-Readable Medium

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1425 (e.g., software 1300, a program, an application, an applet, an app, or other executable code) for causing the machine 1400 to perform any one or more of the methodologies discussed herein may be executed. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1425, sequentially or otherwise, that specify actions to be taken by the machine 1400. Further, while only a single machine 1400 is illustrated, the term “machine” shall also be taken to include a collection of machines 1400 that individually or jointly execute the instructions 1425 to perform any one or more of the methodologies discussed herein.

The machine 1400 may include processors 1410, memory 1430, and I/O components 1450, which may be configured to communicate with each other via a bus 1405. In an example embodiment, the processors 1410 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 1415 and a processor 1420, which may execute the instructions 1425. The term “processor” is intended to include multi-core processors 1410 that may comprise two or more independent processors 1415, 1420 (also referred to as “cores”) that may execute the instructions 1425 contemporaneously. Although FIG. 14 shows multiple processors 1410, the machine 1400 may include a single processor 1410 with a single core, a single processor 1410 with multiple cores (e.g., a multi-core processor), multiple processors 1410 with a single core, multiple processors 1410 with multiple cores, or any combination thereof.

The memory 1430 may include a main memory 1435, a static memory 1440, and a storage unit 1445 accessible to the processors 1410 via the bus 1405. The storage unit 1445 may include a machine-readable medium 1447 on which are stored the instructions 1425 embodying any one or more of the methodologies or functions described herein. The instructions 1425 may also reside, completely or at least partially, within the main memory 1435, within the static memory 1440, within at least one of the processors 1410 (e.g., within the processor's cache memory), or any suitable combination thereof, during execution thereof by the machine 1400. Accordingly, the main memory 1435, the static memory 1440, and the processors 1410 may be considered machine-readable media 1447.

As used herein, the term “memory” refers to a machine-readable medium 1447 able to store data temporarily or permanently and may be taken to include, but not be limited to, random-access memory (RAM), read-only memory (ROM), buffer memory, flash memory, and cache memory. While the machine-readable medium 1447 is shown, in an example embodiment, to be a single medium, the term “machine-readable medium” should be taken to include a single medium or multiple media (e.g., a centralized or distributed database, or associated caches and servers) able to store the instructions 1425. The term “machine-readable medium” shall also be taken to include any medium, or combination of multiple media, that is capable of storing instructions (e.g., instructions 1425) for execution by a machine (e.g., machine 1400), such that the instructions 1425, when executed by one or more processors of the machine 1400 (e.g., processors 1410), cause the machine 1400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1450 may include a wide variety of components to receive input, provide and/or produce output, transmit information, exchange information, capture measurements, and so on. It will be appreciated that the I/O components 1450 may include many other components that are not shown in FIG. 14. In various example embodiments, the I/O components 1450 may include output components 1452 and/or input components 1454. The output components 1452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 1450 may include biometric components 1456, motion components 1458, environmental components 1460, and/or position components 1462, among a wide array of other components. For example, the biometric components 1456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 1458 may include acceleration sensor components (e.g., accelerometer), gravitation sensor components, rotation sensor components (e.g., gyroscope), and so forth. The environmental components 1460 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 1462 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 1450 may include communication components 1464 operable to couple the machine 1400 to a network 1480 and/or devices 1470 via a coupling 1482 and a coupling 1472, respectively. For example, the communication components 1464 may include a network interface component or another suitable device to interface with the network 1480. In further examples, the communication components 1464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1470 may be another machine 1400 and/or any of a wide variety of peripheral devices (e.g., a peripheral device coupled via a USB).

Moreover, the communication components 1464 may detect identifiers and/or include components operable to detect identifiers. For example, the communication components 1464 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 1464 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 1480 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1480 or a portion of the network 1480 may include a wireless or cellular network and the coupling 1482 may be a Code Division Multiple Access (CDMA) connection, a Global System for Mobile communications (GSM) connection, or another type of cellular or wireless coupling. In this example, the coupling 1482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1425 may be transmitted and/or received over the network 1480 using a transmission medium via a network interface device (e.g., a network interface component included in the communication components 1464) and utilizing any one of a number of well-known transfer protocols (e.g., HTTP). Similarly, the instructions 1425 may be transmitted and/or received using a transmission medium via the coupling 1472 (e.g., a peer-to-peer coupling) to the devices 1470. The term “transmission medium” shall be taken to include any intangible medium that is capable of storing, encoding, or carrying the instructions 1425 for execution by the machine 1400, and includes digital or analog communications signals or other intangible media to facilitate communication of such software.

Furthermore, the machine-readable medium 1447 is non-transitory (in other words, not having any transitory signals) in that it does not embody a propagating signal. However, labeling the machine-readable medium 1447 as “non-transitory” should not be construed to mean that the medium is incapable of movement; the medium should be considered as being transportable from one physical location to another. Additionally, since the machine-readable medium 1447 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method comprising:
receiving a request for a particular job listing from a client system associated with a first member of a social networking system;
determining a first employment role for a job associated with the particular job listing;
identifying a source organization for the particular job listing;
identifying one or more similar members, wherein each identified similar member is associated with the source organization and has an employment role similar to the first employment role; and
communicating the particular job listing and the identified one or more similar members to the client system for display.

2. The method of claim 1, wherein determining the first employment role for the job associated with the particular job listing further comprises:
analyzing the particular job listing to determine a list of required skills associated with the job.

3. The method of claim 2, wherein analyzing the particular job listing to determine the list of required skills for the job further comprises:
parsing a text of the particular job listing to identify one or more keywords; and
comparing the one or more keywords to a reference list of skills to determine one or more required skills.

4. The method of claim 3, further comprising:
based on the determined list of required skills, selecting a first employment role from a plurality of employment roles.

5. The method of claim 1, further comprising:
determining, for each respective similar member, a level of connectedness between the respective similar member and the first member;
determining whether the level of connectedness between the respective similar member and the first member is above a predetermined threshold value; and
in accordance with a determination that the level of connectedness between the respective similar member and the first member is above a predetermined threshold value, transmitting a connectedness indication to the client system for display.

6. The method of claim 1, further comprising:
receiving a job listing, wherein each received job listing includes a source organization, a list of required skills, and an associated employment role.

7. The method of claim 2, further comprising:
determining a list of skills associated with the first member; and
generating a job match score based on a comparison between the list of required skills associated with the particular job listing and the list of skills associated with the first member.

8. The method of claim 7, further comprising:
determining a list of skills associated with the one or more similar members;
comparing the list of skills associated with a similar member of the one or more similar members with the list of skills associated with the first member; and
determining one or more skills included in both lists of skills.

9. The method of claim 8, further comprising:
communicating matching skill data to the client system.

10. A system comprising:
one or more processors;
memory; and
one or more programs stored in the memory, the one or more programs comprising instructions for:
receiving a request for a particular job listing from a client system associated with a first member of a social networking system;
determining a first employment role for a job associated with the particular job listing;
identifying a source organization for the particular job listing;
identifying one or more similar members, wherein each identified similar member is associated with the source organization and has an employment role similar to the first employment role; and
communicating the particular job listing and the identified one or more similar members to the client system for display.

11. The system of claim 10, wherein determining the first employment role for the job associated with the particular job listing further comprises:
analyzing the particular job listing to determine a list of required skills associated with the job.

12. The system of claim 11, wherein analyzing the particular job listing to determine the list of required skills for the job further comprises:
parsing a text of the particular job listing to identify one or more keywords; and
comparing the one or more keywords to a reference list of skills to determine one or more required skills.

13. The system of claim 12, further comprising:
based on the determined list of required skills, selecting a first employment role from a plurality of employment roles.

14. The system of claim 10, further comprising:
determining, for each respective similar member, a level of connectedness between the respective similar member and the first member;
determining whether the level of connectedness between the respective similar member and the first member is above a predetermined threshold value; and
in accordance with a determination that the level of connectedness between the respective similar member and the first member is above a predetermined threshold value, transmitting a connectedness indication to the client system for display.

15. The system of claim 10, further comprising:
receiving a job listing, wherein each received job listing includes a source organization, a list of required skills, and an associated employment role.

16. A non-transitory computer-readable storage medium storing instructions that, when executed by the one or more processors of a machine, cause the machine to perform operations comprising:
receiving a request for a particular job listing from a client system associated with a first member of a social networking system;
determining a first employment role for a job associated with the particular job listing;
identifying a source organization for the particular job listing;
identifying one or more similar members, wherein each identified similar member is associated with the source organization and has an employment role similar to the first employment role; and
communicating the particular job listing and the identified one or more similar members to the client system for display.

17. The non-transitory computer-readable storage medium of claim 16, wherein determining the first employment role for the job associated with the particular job listing further comprises:
analyzing the particular job listing to determine a list of required skills associated with the job.

18. The non-transitory computer-readable storage medium of claim 17, wherein analyzing the particular job listing to determine the list of required skills for the job further comprises:
parsing a text of the particular job listing to identify one or more keywords; and
comparing the one or more keywords to a reference list of skills to determine one or more required skills.

19. The non-transitory computer-readable storage medium of claim 18, further comprising:
based on the determined list of required skills, selecting a first employment role from a plurality of employment roles.

20. The non-transitory computer-readable storage medium of claim 16, further comprising:
determining, for each respective similar member, a level of connectedness between the respective similar member and the first member;
determining whether the level of connectedness between the respective similar member and the first member is above a predetermined threshold value; and
in accordance with a determination that the level of connectedness between the respective similar member and the first member is above a predetermined threshold value, transmitting a connectedness indication to the client system for display.
